(19) United States
(12) Patent Application Publication
(10) Pub. No.: US 2016/0073671 A1
(43) Pub. Date: Mar. 17, 2016

(54) MICROBIAL BIOMASS COMPRISING FOOD PRODUCTS

(71) Applicant: Savage River, Inc. dba Beyond Meat, El Segundo, CA (US)

(72) Inventors: Timothy Geistlinger, Redondo Beach, CA (US); Michael S. Timmons, Los Angeles, CA (US); Deya Suarez-Trujillo, Redondo Beach, CA (US)

(21) Appl. No.: 14/855,212

(22) Filed: Sep. 15, 2015

Related U.S. Application Data
(60) Provisional application No. 62/051,710, filed on Sep. 17, 2014.

(51) Int. Cl. A23L 1/314; A23L 1/231

(52) U.S. Cl. CPC A23L 1/31481; A23L 1/31436; A23L 1/231; A23V 2002/00

(57) ABSTRACT

Provided are food products that have meat-like structure, texture, and properties, and that comprise substantial amounts of microbial biomass. Also provided are methods and processes for producing such food products.

### RELATED APPLICATIONS

This application claims priority from Provisional Application Ser. No. 62/051,710, filed on Sep. 17, 2014, which is hereby incorporated by reference in its entirety.

### FIELD OF THE INVENTION

Provided are food products that have structures, textures, and other properties comparable to those of animal meat and that comprise substantial amounts of microbial biomass. Also provided are cost-effective processes for the production of such food products.

### BACKGROUND OF THE INVENTION

The health and environmental benefits of vegetarian and vegan diets are broadly recognized, and consumers are increasingly making a conscious effort to decrease their intake of animal-derived food items. To meet the rising demand for vegetarian and vegan dietary products, food scientists have engaged in efforts to develop food products that are not derived from animals but provide similar eating experiences and nutritional benefits as animal-derived food products. Such efforts have had limited success in creating food products that share important textural and sensory qualities of animal meat, and consumer satisfaction with and acceptance of the new food products have been low.

One barrier for acceptance is that the new vegetarian/vegan protein food products do not have the widely enjoyed textural and sensory characteristics of animal meat products. At the microscopic level, animal meat consists of a complex three-dimensional network of protein fibers that provides cohesion and firmness and that traps polysaccharides, fats, flavors, and moisture. In contrast, many of the available high protein vegetarian/vegan food products have looser and less complex protein structures (i.e., no protein fibers or limited sets of protein fibers that are aligned in only one direction and within a single plane) that disassemble easily during chewing, requiring an unsatisfactory, diminutive bite force and chewing time, and imparting sensations of “mealiness”, “rubberiness”, “sponginess”, and/or “sliminess”. Without a three-dimensional matrix, the new protein food products also cannot trap moisture and flavor effectively.

Another reason for the limited success of the available vegetarian/vegan protein products is that the heavy reliance on soy protein in the production of many such products conflicts with the rise in frequency of sensitivities and intolerances to soy. The reason for the widespread use of soy protein or soy protein isolate is that soy protein has an Essential Amino Acid Score (EAS) of 108 and a Protein Digestibility Corrected Amino Acid Score (PDCAAS) of 1.0. An EAS of 100 or greater means that the protein source is well balanced and will provide good protein nutrition for human consumption. A PDCAAS of 1.0 reports that a given protein source is fully digestible by humans whereas numbers below 1.0 express incomplete digestion. The scores of soy protein compare rather favorably with those of chicken meat, which has an EAS of 100 and a PDCAAS of 1.0, and of beef meat, which has an EAS of 100 and a PDCASS of 0.92. Attempts to replace soy protein with other plant proteins have been thwarted by the poor EAS and PDCAAS of many plant protein sources. For example, pea protein has an EAS of only 80 and a PDCAAS of only 0.69, and gluten, one of the most common dietary vegan proteins, has an EAS of less than 70 and a PDCAAS of less than 0.3.

Lastly, the production of vegetarian/vegan protein products is costly due to the expensive sourcing of suitable non-animal protein, and the production cost is passed on to the consumers.

There exists, therefore, an unmet need for non-animal-derived food products that have the structure, texture, properties, and nutritional profile of animal meat, and that can be produced at a cost that is more competitive with the cost of production of animal meat. The present invention provides such food products, as well as processes for their production.

### SUMMARY OF THE INVENTION

One aspect of the present invention provides meat structured protein products that comprise at least about 2% by weight of microbial biomass, at least about 30% by weight of water, and protein fibers that are substantially aligned. In some embodiments, the microbial biomass is algae biomass. In some embodiments, the microbial biomass is fungi biomass. In some embodiments, the microbial biomass is bacteria biomass. In some embodiments, the meat structured protein products comprise at least about 2% by weight of whole microbes. In some embodiments, the meat structured protein products further comprise non-microbial ingredients, including non-microbial protein, carbohydrate, and/or lipid. In some embodiments, the non-microbial ingredients are derived from multicellular plant sources. In some embodiments, the meat structured protein products have eating qualities and mouth feels that are substantially similar to those of animal meat. In some embodiments, the meat structured protein products are gluten-free and do not comprise any cross-linking agents.

Another aspect of the present invention provides processes for producing the meat structured protein products. The process typically comprises the steps of combining microbial biomass and water and optional other ingredients to form a dough; shearing and heating the dough so as to denature the proteins in the microbial biomass and to produce protein fibers that are substantially aligned; and setting the dough to fix the fibrous structure previously obtained.

Yet another aspect of the present invention provides extended meat products. In general, the extended meat products comprise animal meat products and meat structured protein products comprising at least about 2% by weight of microbial biomass, at least about 30% by weight of water, and protein fibers that are substantially aligned.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows images of meat structured protein products as provided herein comprising yeast biomass in accordance with a representative embodiment of the present invention; and

FIG. 2 shows images of meat structured protein products as provided herein comprising algae or bacteria biomass in accordance with a representative embodiment of the present invention.

### DETAILED DESCRIPTION OF THE INVENTION

Unless defined otherwise, all technical and scientific terms used herein have the same meaning as is commonly understood by one of ordinary skill in the art to which this disclosure pertains.

### Definitions

The term “animal meat” as used herein refers to flesh derived from skeletal muscle or from other organs (e.g., kidney, heart, liver, gallbladder, intestine stomach, bone marrow, brain, thymus, lung, tongue), or parts thereof, derived from an animal. The animal meat can be dark or white meat. Suitable animals from which the animal meat can be derived include but are not limited to cattle, lamb, mutton, horse, poultry (e.g., chicken, duck, goose, turkey), fowl (any bird species, pigeon, dove, grouse, partridge, ostrich), fresh or salt water fish (e.g., catfish, tuna, sturgeon, salmon, bass, muskie, pike, bowfin, gar paddlefish, bream, carp, trout, walleye, snakehead, crappie, sister, muscle, scallop, abalone, squid, octopus, sea urchin, tunicate), crustacean (e.g., crab, lobster, shrimp, barnacle), game animals (e.g., buffalo, deer, fox, wild pig, elk, moose, reindeer, caribou, antelope, rabbit, bear, beaver, muskrat, opossum, raccoon, armadillo, porcupine, bison, buffalo, boar, pheasant, quail, reptiles (e.g., snakes, turtles, lizards), any insect or other arthropod, rodent (nutria, guinea pig, rat, mice, vole, groundhog, nutria, capybara), kangaroo, emu, alligator, crocodile, turtle, marmot, possum, squirrel, whale, and seal. The term refers to ground, chopped, shredded, or otherwise processed animal meat. The term encompassed both uncooked, cooking, and cooked animal meat unless otherwise indicated herein or clearly contradicted by context.

The term “algae” as used herein refers to single-celled eukaryotes that have chlorophyll as their primary photosynthetic pigment and that lack a sterile covering of cells around their reproductive cells.

The terms “algae biomass”, “algae protein”, “algae carbohydrate”, and “algae lipid” as used herein refer to biomass, protein, carbohydrate, and lipid, respectively, derived from algae. The protein, carbohydrate, or lipid may be native to algae or not native but produced by algae that were modified.

The term “bacteria” as used herein refers to prokaryotic microorganisms. The term as used herein includes cyanobacteria (blue-green algae).

The term “bacteria biomass”, “bacteria protein”, “bacteria carbohydrate”, and “bacteria lipid” as used herein refer to biomass, protein, carbohydrate, and lipid, respectively, derived from bacteria. The protein, carbohydrate, or lipid may be native to bacteria or not native but produced by bacteria that were modified.

The term “biomass” as used herein refers to material derived from a living or dead biological organism. The term extends to material that is native to the organism as well as material that is not native to the organism. Biomass comprises both intracellular material (i.e., biomolecules present inside microbial cells, such as, for example, biomolecules found in the cytoplasm, cytoskeleton, or sub-cellular organelles of microbial cells) and cell envelope material (i.e., biomolecules present in the plasma membrane or cell wall of microbial cells). In some embodiments, biomass also comprises extracellular material (i.e., material that is secreted by microbial cells). Biomass may comprise whole microbes (inactivated or alive), fragmented microbes, microbial sub-cellular fractions, partially purified microbial macromolecules (e.g., RuBisCo), microbial macromolecular assemblages (e.g., microbial cell wall complexes, extracellular mucilages), or combinations thereof. Biomass may also comprise elements from the microbes' original fermentations, cultures, or growth environments.

The term “chewiness” as used herein refers to a Texture Profile Analysis (TPA) parameter of a food product and is calculated as the product of Gumminess and Springiness. It is thought to express the energy required to chew a food product to a state where it is ready for swallowing.

The term “cohesiveness” as used herein refers to a TPA parameter of a food product and is calculated from the area of work during the first compression of the food product. It is thought to express the structural integrity of a food product.

The term “controlled conditions” as used herein refers to conditions that are defined by a human. Examples of conditions that can be defined by a human include but are not limited to the level of oxygenation, pH, salt concentration, temperature, and nutrient (e.g., carbon, nitrogen, sulfur) availability. A microbe grown under “controlled conditions” may produce a distribution of proteins, carbohydrates, lipids, and compounds that is not native to the microbe.

The term “crosslinking” as used herein refers to the chemical, enzymatic, or chemoenzymatic formation of new covalent bonds between polypeptides.

The term “dough” as used herein refers to a blend of dry ingredients (“dry mix”; e.g., proteins, carbohydrates, and lipids including liquid oils) and liquid ingredients (“liquid mix”; e.g., water or juice [i.e., liquid based extract from a natural source such as a plant or any part of a plant]) from which a meat structured protein product as provided herein is produced through the application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous structure (e.g., by rapid temperature and/or pressure change, rapid dehydration, chemical fixation, redox).

The acronym “EAS” refers to the Essential Amino Acid Score, which is derived from the content of essential amino acids in a protein. It expresses how close a protein is to the optimal distribution of amino acids recommended by the Institute of Medicine's Food and Nutrition Board. The EAS is calculated with the following formula: EAS=100× (amount of the limiting essential amino acid per 100 g protein/recommended daily amount of the same essential amino acid per 100 g animal meat).

The terms “extending”, and its passive “extended”, as used herein refer to improving the nutritional and/or moisture content of a food product.

The term “extended meat product” as used herein refers to animal meat that is extended with microbial biomass.

The term “fungus” as used herein refers to a member of the kingdom of fungi.

The term “fungal biomass”, “fungal protein”, “fungal carbohydrate”, and “fungal lipid” as used herein refer to biomass, protein, carbohydrate, and lipid, respectively, derived from fungi. The protein, carbohydrate, or lipid may be native to fungi or not native but produced by fungi that were modified.

The term “gumminess” as used herein refers to a TPA parameter of a food product and is the product of Hardness and Cohesiveness.

The term “hardness” as used herein refers to a TPA parameter of a food product and is calculated from the peak force of the first compression of the food product (see Example 1). It is thought to correlate with the force required to compress a food product between molars during chewing.

The term “high heat hydration integrity”, or its acronym “HHHI”, as used herein refers to the integrity of a sample to not fragment upon high heat hydration (i.e., hydration in water at 100° C. for 30 min).

The term “hydrated protein fibrous product” as used herein refers to the product obtained after a protein fibrous product has absorbed water (i.e., is hydrated or marinated).

The term “meat structured protein product” as used herein refers to a food product that is not derived from an animal but has structure, texture, color, and/or other properties comparable to those of animal meat. The term refers to both protein fibrous product and post-processed protein fibrous products (uncooked, cooking, and/or cooked) unless otherwise indicated herein or clearly contradicted by context.

The terms “microbe” and “microbial source” as used herein are abbreviations for microorganism, and refer to a unicellular organism. As used herein, the terms include all bacteria, all archaea, unicellular protista, unicellular animals, unicellular plants, unicellular fungi, unicellular algae, all protozoa, and all chromista.

The terms “microbial biomass”, “microbial protein”, “microbial carbohydrate”, “microbial lipid”, and “microbial compound” as used herein refer to biomass, protein, carbohydrate, lipid, and compound that is produced by a microbe. The protein, carbohydrate, lipid, or compound may be native to the microbe or not native but produced by the microbe because the microbe was modified.

The term “modified microbe” as used herein refers to a microbe that is altered from its native state (e.g., mutated, genetically engineered).

The term “moisture content” and its acronym “MC” as used herein refer to the amount of moisture in a material as measured in an analytical method calculated as percentage change in mass following the evaporation of water from a sample.

The term “mouth feel” as used herein refers to the overall appeal of a food product, which stems from the combination of several characteristics that together provide a satisfactory sensory experience.

The term “native” as used herein refers to what is natural. For example, a protein that is native to a microbe is naturally produced by the microbe when the microbe is grown under natural or controlled conditions.

The term “natural” or “naturally occurring” as used herein refers to what is found in nature.

The terms “optional” or “optionally” mean that the feature or structure may or may not be present, or that an event or circumstance may or may not occur, and that the description includes instances where a particular feature or structure is present and instances where the feature or structure is absent, or instances where the event or circumstance occurs and instances where the event or circumstance does not occur.

The acronym “PDCAAS” refers to the Protein Digestibility Corrected Amino Acid Score. The PDCAAS is a measure of protein quality based on both the amino acid requirements of humans and their ability to digest it. It is calculated as follows: (mg of limiting amino acid in 1 g of test protein/mg of same amino acid in 1 g of reference protein)×fecal true digestibility percentage.

The term “percent dissolved solids”, and its acronym “PDS”, as used herein refers to the percentage of original solid mass that was solubilized during the hydration step of the water holding capacity assay.

The term “pH and/or ionic strength adjusting agent” as used herein refers to an agent that raises or lowers the pH and/or the ionic strength of a solution. The pH and/or ionic strength adjusting agent can have an acidic (less than 7) pH (“acidic pH and/or ionic strength adjusting agent”) or a basic (more than 7) pH (“basic pH and/or ionic strength adjusting agent”).

The term “plant protein” as used herein refers to protein whose amino acid sequence matches the amino acid sequence of protein found in a plant.

The term “post-processed protein fibrous product” as used herein refers to the food product that is obtained after a protein fibrous product has undergone post-processing. The term encompasses hydrated protein fibrous product.

The term “post-processing” as used herein refers to processing the protein fibrous product undergoes after its fibrous structure is generated and fixed, including but not limited to hydration, marination, and drying.

The term “protein” as used herein refers to a polymeric form of amino acids of any length, which can include coded and non-coded amino acids, chemically or biochemically modified or derivatized amino acids, and polypeptides having modified peptide backbones.

The term “protein fiber” as used herein refers to a continuous filament of discrete length made up of protein held together by intermolecular forces such as disulfide bonds, hydrogen bonds, electrostatic bonds, hydrophobic interactions, peptide strand entanglement, and Maillard reaction chemistry creating covalent cross-links between side chains of proteins.

The term “protein fibrous product” as used herein refers to the food product obtained from a dough after application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous structure (e.g., by rapid temperature and/or pressure change, rapid dehydration, chemical fixation, redox).

The term “springiness” as used herein refers to a TPA parameter of a food product and is calculated as the ratio of the food product's height during the second compression and the original compression distance. It is thought to correlate with the ability of a food product to spring back after deformation.

The term “resilience” as used herein refers to aTPA parameter of a food product and is calculated by dividing the upstroke energy of the first compression by the downstroke energy of the first compression. It is thought to express how well a food product fights to regain its original shape.

The term “texture” as used herein refers to mechanical characteristics of a food product that are correlated with sensory perceptions of the food product.

The term “substantially aligned” as used herein refers to an arrangement of protein fibers such that a significantly high percentage of the fibers are contiguous to each other at less than about a 45° angle when viewed in a horizontal plane.

The term “Texture Profile Analysis” and its acronym “TPA” as used herein refer to the evaluation of textural properties of a material by subjecting the material to a controlled force from which a deformation curve of its response is generated. Methods for TPA are disclosed, for example, in U.S. Utility application Ser. No. 14/687,803 filed on Apr. 15, 2015.

The term “yeast biomass”, “yeast protein”, “yeast carbohydrate”, and “yeast lipid” as used herein refer to biomass, protein, carbohydrate, and lipid, respectively, derived from yeast. The protein, carbohydrate, or lipid may be native to yeast or not native but produced by yeast that were modified.

The term “Warner-Bratzler shear strength” and its acronym “WBS strength” as used herein refer to the maximum force needed to mechanically shear through a sample using a 3.2 mm blade that is run at a speed of 5 mm/sec. A method for measuring WBS is disclosed in U.S. Utility application Ser. No. 14/687,803 filed on Apr. 15, 2015, which is hereby incorporated by reference in its entirety. The WBS strength is an established measure of meat tenderness.

The term “water activity” and its acronym “WA” as used herein refer to the amount of free water in a sample.

The term “water holding capacity”, and its acronym “WHC”, as used herein refer to the ability of a food product to prevent water from being released from its 3-dimensional protein structure during the application of force, pressing, centrifugation, or heating.

The term “whole cell” as used herein refers to an intact cell, consisting of a cell wall and/or cell membrane that envelop(s) the cytoplasm, cytoskeleton, genetic material (e.g., DNA), and intracellular organelles.

The terms “a” and “an” and “the” and similar referents as used herein refer to both the singular and the plural, unless otherwise indicated herein or clearly contradicted by context.

The term “about” as used herein refers to greater or lesser than the value or range of values stated by 1/10 of the stated values, but is not intended to limit any value or range of values to only this broader definition. For instance, a value of “about 30%” means a value of between 27% and 33%. Each value or range of values preceded by the term “about” is also intended to encompass the embodiment of the stated absolute value or range of values.

Recitation of ranges of values herein are merely indented to serve as a shorthand method of referring individually to each separate value inclusively falling within the range, unless otherwise indicated herein, and each separate value is incorporated into the specification as if it were individually recited herein.

### Meat Structured Protein Products Comprising Microbial Biomass

In one aspect, provided herein are meat structured protein products that comprise substantial amounts of microbial biomass.

The meat structured protein products provided herein have several advantages. For one, the ingredients of the meat structured protein products (e.g., proteins, polysaccharides, lipids) can be more cheaply produced and extracted from microbes than they can from higher (i.e., multicellular) plants or animals. Moreover, the sourcing of ingredients has a smaller negative impact on the environment because microbes can be grown at higher densities than higher plants and animals, using less water, electricity, carbon, salts, and other resources on a per protein pound basis. Furthermore, many microbial proteins have high EAS's and PDCAAS's (for example, yeast protein has an EAS of 132 and a PDCAAS of 1.0). Lastly, microbes may comprise certain ingredients or certain relative amounts of certain ingredients that are advantageous to the process of forming protein structures that resemble those found in animal meat and of imparting other meat-like properties (e.g., taste, mouth feel, moisture content), or that increase the nutritional content of a meat structured protein product. And, if not inherently able to produce such ingredients or relative amounts of such ingredients, microbes can be manipulated to do so, for example, by selecting genetic variants or genetic engineering of microbes.

The meat structured protein products provided herein comprise at least about 2% by weight of microbial biomass. The microbial biomass may be derived from a single or from multiple natural and/or modified microbial sources. In some embodiments, the meat structured protein products comprise between about 2% and about 70%, between about 5% and about 70%, between about 10% and about 70%, between about 20% and about 70%, between about 30% and about 60%, between about 2% and about 10%, between about 3% and about 9%, between about 4% and about 8%, between about 4% and about 7%, between about 2% and about 15%, between about 3% and about 12%, between about 4% and about 10%, between about 5% and about 15%, between about 2% and about 30%, between about 3% and about 30%, between about 4% and about 30%, between about 5% and about 30%, between about 10% and about 20%, between about 20% and about 30%, between about 30% and about 40%, between about 40% and about 50%, between about 50% and about 60%, between about 60% and about 70%, between about 10% and about 30%, between about 20% and about 40%, between about 30% and about 50%, between about 40% and about 60%, between about 50% and about 70%, between about 10% and about 40%, between about 20% and about 50%, between about 30% and about 60%, between about 40% and about 70%, between about 10% and about 50%, between about 20% and about 60%, or between about 30% and about 70% by weight of microbial biomass. In preferred embodiments, the meat structured protein products comprise at least about 2% by weight of yeast biomass. In other preferred embodiments, the meat structured protein products comprise at least about 2% by weight of algae biomass. In yet other preferred embodiments, the meat structured protein products comprise at least about 2% by weight of bacteria biomass. The microbial biomass content of a food product can be analyzed by a number of methods known in the art. Examples of such methods include but are not limited to histological staining of intact cells followed by microscopy and scoring of intact cells per unit volume using a hemocytometer; relative protein quantitation by mass spectroscopy of a control protein in the microbe relative to the other ingredients in the product; and quantitative PCR analysis of specific DNA elements within the microbe relative to the total amount of product sample.

The microbial biomass may comprise microbial protein such that the meat structured protein products provided herein may comprise at least about 1% by weight of microbial protein. The microbial protein is comprised of a mixture of polypeptide molecules having various amino acid sequences, and of a mixture of intracellular protein (i.e., protein present inside microbial cells, such as, for example, protein found in the cytoplasm, cytoskeleton, or sub-cellular organelles of microbial cells) and cell envelope protein (i.e., protein present in the plasma membrane or cell wall of microbial cells). Examples of intracellular and cell envelope proteins include but are not limited to actin (ACT1, ABY1, END7), actin-related protein 2 (ARP2, ACT2), actin-related protein 1 (ARP1, ACT5), F-actin-capping protein subunit beta (CAP2), actin-related protein 3 (ARP3, ACT4), alcohol dehydrogenase, alkaline phosphatase, carboxypeptidase Y, cytochrome oxidase subunit III, cytosine deaminase, dolichol phosphate mannose synthase, hexokinase, homocitrate synthase (Lys20, Lys21), 3-phosphoglycerate kinase, protein disulfide isomerase, and fibrillarin (Nop1). In some embodiments, the microbial protein also comprises extracellular protein (i.e., protein that is secreted by microbial cells). In some embodiments, the microbial protein has an EAS of at least about 90. In some embodiments, the microbial protein has a PDCAAS of at least about 0.75. In some embodiments, the meat structured protein products comprise between about 1% and about 70%, between about 5% and about 70%, between about 10% and about 70%, between about 20% and about 70%, between about 30% and about 60%, between about 1% and about 10%, between about 2% and about 9%, between about 3% and about 8%, between about 4% and about 7%, between about 5% and about 6%, between about 1% and about 15%, between about 3% and about 12%, between about 4% and about 10%, between about 5% and about 15%, between about 2% and about 30%, between about 3% and about 30%, between about 4% and about 30%, between about 5% and about 30%, between about 10% and about 20%, between about 20% and about 30%, between about 30% and about 40%, between about 40% and about 50%, between about 50% and about 60%, between about 60% and about 70%, between about 10% and about 30%, between about 20% and about 40%, between about 30% and about 50%, between about 40% and about 60%, between about 50% and about 70%, between about 10% and about 40%, between about 20% and about 50%, between about 30% and about 60%, between about 40% and about 70%, between about 10% and about 50%, between about 20% and about 60%, or between about 30% and about 70% by weight of microbial protein. In preferred embodiments, the meat structured protein products comprise at least about 1% by weight of yeast protein. In other preferred embodiments, the meat structured protein products comprise at least about 1% by weight of algae protein. In yet other preferred embodiments, the meat structured protein products comprise at least about 1% by weight of bacteria protein.

The microbial biomass may further comprise microbial carbohydrate such that the meat structured protein products provided herein may further comprise at least about 0.5% by weight of microbial carbohydrate. The microbial carbohydrate is comprised of a mixture of carbohydrate molecules, and of a mixture of intracellular carbohydrate (i.e., carbohydrate present inside the microbial cells) and cell envelope carbohydrate (i.e., carbohydrate present in the plasma membrane or cell wall of the microbial cells, such as, for example, cellulose, mannans, xylans, alginic acid, sulfonate polysaccharides, agarose, carrageenan, porphyran, furcellaran, funoran, chitin, alpha-glucans, beta-glucans, and murein). In some embodiments, the microbial carbohydrate also comprises extracellular carbohydrate (i.e., carbohydrate that is secreted by microbial cells). Methods for determining the content of chitin or beta-glucans are known in the art as are methods for determining the polysaccharide components in the cell wall of yeasts. In some embodiments, the meat structured protein products comprise between about 0.5% and about 10%, between about 1% and about 8%, between about 2% and about 6%, between about 3% and about 5%, or between about 1.5% and about 3.5% by weight of microbial carbohydrate. In preferred embodiments, the meat structured protein products comprise at least about 0.5% by weight of yeast carbohydrate. In other preferred embodiments, the meat structured protein products comprise at least about 0.5% by weight of algae carbohydrate. In yet other preferred embodiments, the meat structured protein products comprise at least about 0.5% by weight of bacteria carbohydrate.

The microbial biomass may further comprise microbial lipid such that the meat structured protein products provided herein may further comprise at least about 0.1% by weight of microbial lipid. The microbial lipid is comprised of a mixture of lipid molecules, and of a mixture of intracellular lipid (i.e., lipid present inside the microbial cells, such as, for example, lipid present in plasma membranes of intracellular organelles or second messenger signaling lipid [e.g., inositol triphosphate, diacylglycerol]) and cell envelope lipid (i.e., lipid present in the plasma membrane of microbial cells, such as, for example, phospholipids [e.g., cardiolipin], ergosterol, second messenger signaling lipids [e.g., diglyceride]). In some embodiments, the microbial lipid also comprises extracellular lipid (i.e., lipid that is secreted by the microbial cells). Methods for measuring, for example, ergosterol are known in the art. In some embodiments, the meat structured protein products comprise between about 0.1% and about 10%, between about 0.2% and about 8%, between about 0.3% and about 6%, between about 0.4% and about 5%, or between about 0.5% and about 4% by weight of microbial lipid. In preferred embodiments, the meat structured protein products comprise at least about 0.1% by weight of yeast lipid. In other preferred embodiments, the meat structured protein products comprise at least about 0.1% by weight of algae lipid. In yet other preferred embodiments, the meat structured protein products comprise at least about 0.1% by weight of bacteria lipid.

The microbial biomass may further comprise other microbial compounds such that the meat structured protein products provided herein further comprise such other microbial compounds.

In some embodiments, the meat structured protein products provided herein may comprise at least some of the microbial biomass in the form of live or dead whole cells. In some such embodiments, the whole cells may serve as encapsulates of cellular content that may be released under certain trigger conditions to impart or enhance advantageous characteristics on the meat structured protein products. Such advantageous characteristics include but are not limited to color, color stability, cooking color change profile, aroma, aroma stability, cooking aroma release profile, flavor, flavor stability, cooking flavor production profile, chewiness, chewiness stability, cooking chewiness profile, gumminess, gumminess stability, cooking gumminess profile, springiness, springiness stability, cooking springiness profile, cohesiveness, cohesiveness stability, cooking cohesiveness profile, resilience, resilience stability, cooking resilience profile, adhesiveness, adhesiveness stability, cooking adhesiveness profile, hardness, hardness stability, cooking hardness profile, MC, MC stability, cooking moisture loss profile, juiciness, juiciness stability, cooking juiciness profile, head space gas chromatography-mass spectrometry (GCMS) pattern, head space GCMS pattern stability, cooking head space GCMS pattern profile, protein content, lipid content, carbohydrate content, fiber content, cooking sizzle sound profile, cooking melted fat release profile, cook loss, cook loss profile, doneness profile, heat tolerance, texture, texture stability, cooking texture change profile, and combinations thereof. In this context, attribute stabilities (e.g., color stability, aroma stability, flavor stability, chewiness stability, gumminess stability, springiness stability, cohesiveness stability, resilience stability, adhesiveness stability, hardness stability, MC stability, juiciness stability, head space gas chromatography-mass spectrometry (GCMS) pattern stability, texture stability) refer to the persistence of the attributes over the course of time (e.g., over the course of time in storage), and cooking attribute profiles (e.g., cooking color change profile, cooking aroma release profile, cooking flavor production profile, cooking chewiness profile, cooking gumminess profile, cooking springiness profile, cooking cohesiveness profile, cooking resilience profile, cooking adhesiveness profile, cooking hardness profile, cooking moisture loss profile, cooking head space GCMS pattern profile, cooking sizzle sound profile, cooking melted fat release profile, cook loss profile, doneness profile, doneness profile, cooking texture change profile) refer to the profiles of attributes over the course of a cooking process. Examples of cellular content that may be comprised in the whole cells include but are not limited to coloring agents, color stabilizers, color enhancers, aroma agents, aroma stabilizers, aroma enhancers, precursor molecules (i.e., molecules that can specifically or non-specifically react with each other or other compounds that impart or enhance advantageous characteristics), flavoring agents, flavor enhancers, flavor stabilizers, pH adjusting agents, binding agents, micronutrients, essential nutrients, stabilizing agents, and crosslinking agents. Examples of trigger conditions under which such cellular content may be released include but are not limited to temperature (e.g., cooking, cooling, freezing), pH, pressure, shear (e.g., chewing), level of oxygenation, time, and combinations thereof. In some embodiments, the trigger conditions are temperatures lower than ambient temperature (e.g., below 25° C., below about 20° C., below about 15° C., below about 10° C., below about 4° C., below about 0° C., below about −15° C., between about 20° C. and 25° C., between about 15° C. and about 20° C., between about 10° C. and 15° C., between about 4° C. and about 10° C., or between about 0° C. and about 4° C., between about −15° C. and about 0° C.). In other embodiments, trigger conditions are temperatures higher than ambient temperature (e.g., at least about 25° C., at least about 50° C., at least about 75° C., at least about 100° C., at least about 125° C., between about 25° C. and about 50° C., between about 50° C. and about 75° C., between about 75° C. and about 100° C., or between about 100° C. and about 125° C.). In some embodiments, trigger conditions are alkaline pH (e.g., pH of greater than 7, between 7 and about 8, between 7 and about 9, between about 8 and about 9, between about 7.05 and about 10). In other embodiments, trigger conditions are acidic pH (e.g., pH of less than 7, between about 6 and 7, between about 5 and 7, between about 4 and about 5). For example, the microbe may comprise flavoring agents that are only released during biting or cooking, or coloring agents that are released during cooking, or crosslinking agents that are released at a specific pH, during cooking, at a specific time, or during aging. In some embodiments, the meat structured protein products comprise at least about 2% by weight of whole cell microbes. In some embodiments at least about 10%, at least about 20%, at least about 50%, at least about 75% or at least about 95% of the microbial biomass in the meat structured protein products is in the form of whole cell microbes. Methods for assaying for the presence of whole and live cells, using, for example, PCR methods, are known in the art. For example, the rDNA PCR-RFLP method can be used for the amplification of rDNA repeats such as the ITS1 or ITS2 spacers embedded in the 5.8S or 26S rRNA genes of yeast; the mtDNA PCR-RFLP method can be used for the amplification and detection of strain specific mitochondrial DNA polymorphisms; PCR primers targeted to Ty1 retrotransposon delta sequences can be used to detect yeast DNA and differentiate between strains; hypervariable yeast microsatellite sequences can be targeted by PCR and used both to detect and type various yeast DNAs; the PCR-DGGE method can be used to amplify yeast 26S rDNA, and microbial identification can be done by sequencing the isolated PCR fragments; and real time PCR can be targeted to the intron sequences of yeast actin genes and used for species identification. There are also commercially available products that can be used for yeast detection by PCR and/or fingerprinting, such as, for example, the Saccharomyces cerevisiae PCR Detection Kit (Norgen Biotek Corporation, Thorolt, Canada), which detects a region of the yeast genome; the BAX® System Q7 (Dupont, Hayward, Calif.), which detects pan-fungal rRNA; the Foodproof® Yeast and Mold Quantification Lyokit (Biotecon Diagnostics, Potsdam, Germany), which detects yeast DNA; the DiversiLab fragment based genotype method (Biomérieux, Durham, N.C.), which detects and fingerprints repetitive fungal sequences.

The meat structured protein products provided herein may also comprise non-microbial ingredients. The non-microbial ingredients may be derived from any one natural or modified natural source or from multiple natural or modified natural sources. In some embodiments, the non-microbial ingredients are not derived from a natural source but are identical or similar to ingredients found in a natural source (for example, non-microbial protein may be synthetically or biosynthetically generated but comprise polypeptide molecules that have an identical or similar amino acid sequence as polypeptide molecules found in a natural source). The non-microbial ingredients may be comprised of molecules having identical structures, or of a mixture of molecules having at least 2 different structures. In some embodiments, the meat structured protein products comprise between about 5% and about 68% by weight of non-microbial protein, between about 0.5% and about 10% by weight of non-microbial lipid, between about 0.5% and about 20% by weight of non-microbial carbohydrate. In some embodiments, the meat structured protein products comprise a similar total protein content (i.e., protein from microbial and non-microbial sources) as animal meat. In some embodiments, the meat structured protein products comprise between about 30% and about 50% by weight of total protein, between about 1% and about 5% by weight of total carbohydrate, between about 0.1% and about 2% by weight of total edible fiber, between about 1% and about 5% by weight of total lipid, and between about 40% and about 60% by weight of water. In some embodiments, the meat structured protein products comprise less than about 2%, less than about 1%, less than about 0.5%, less than about 0.25%, less than about 0.1%, or less than about 0.005% by weight of saturated fat. Protein content of a food product can be determined by a variety of methods, including but not limited to AOAC International reference methods AOAC 990.03 and AOAC 992.15. Lipid content of a food product can be determined by a variety of methods, including but not limited to AOAC International reference method AOAC 954.02.

In some embodiments, the non-microbial protein is protein derived from multicellular plant. In some such embodiments, the meat structured protein products comprise between about 5% and about 68%, between about 20% and about 60%, between about 30% and about 50%, between about 34% and about 50%, between about 30% and about 60%, between about 40% and about 68%, between about 40% and about 60%, between about 5% and about 35%, between about 10% and about 30%, between about 15% and about 25%, between about 17% and about 25%, between about 15% and about 30%, between about 20% and about 35%, or between about 20% and about 30% by weight of multicellular plant protein. In some embodiments, the meat structured protein products comprise pea protein. In some embodiments, the meat structured protein products comprise between about 5% and about 68%, between about 20% and about 60%, between about 30% and about 50%, between about 40% and about 60%, or between about 34% and about 46% by weight of Pisum sativum protein.

In some embodiments, the non-microbial lipid is lipid derived from multicellular plant. In some embodiments, the meat structured protein products provided herein may comprise between about 0.5% and about 10%, between about 2% and about 8%, between about 2% and about 6%, between about 2% and about 5%, between about 2% and about 4%, between about 3% and about 6%, between about 3% and about 5%, between about 3% and about 4%, between about 4% and about 5%, between about 5% and about 10%, between about 0.5% and about 5%, between about 1% and about 4%, between about 1% and about 3%, between about 1% and about 2%, between about 1.5% and about 3%, between about 1.5% and about 2.5%, between about 1.5% and about 2%, between about 2% and about 2.5%, or between about 2.5% and about 5% by weight of multicellular plant lipid.

In some embodiments, the non-microbial carbohydrate is carbohydrate derived from multicellular plant. In some embodiments, the meat structured protein products provided herein comprise between about 0.5% and about 20%, between about 1% and about 10%, between about 2% and about 9%, between about 1% and about 5%, between about 2% and about 4%, between about 1% and about 3%, between about 5% and about 15%, between about 0.5% and about 10%, between about 0.5% and about 5%, between about 0.5% and about 2.5%, between about 0.5% and about 1.5%, between about 1% and about 3%, or between about 2.5% and about 7.5% by weight of multicellular plant carbohydrate. In some embodiments, the meat structured protein products comprise between about 0.1% and about 3%, between about 1% and about 3%, between about 2% and about 3%, 0.1% to about 1.5%, between about 0.5% and about 1.5%, or between about 1% and about 1.5% by weight of multicellular plant starch. In some embodiments, the meat structured protein products comprise pea starch. In some such embodiments, the meat structured protein products comprise between about 0.1% and about 3%, between about 1% and about 3%, between about 2% and about 3%, between about 0.1% and about 1.5%, between about 0.5% and about 1.5%, or between about 1% and about 1.5% by weight of Pisum sativum starch. In some embodiments, the meat structured protein products comprise between about 0.1% and about 5%, between about 0.1% and about 3%, between about 0.1% and about 2%, between about 0.1% and about 1%, between about 0.4% and about 0.6%, between about 0.05% and about 2.5%, between about 0.05% and about 1.5%, between about 0.05% and about 1%, or between about 0.0.5% and about 0.5% by weight of multicellular plant edible fiber. In some embodiments, the meat structured protein products comprise edible pea fiber. In some such embodiments, the meat structured protein products comprise between 0.1% and about 5%, between about 0.1% and about 3%, between about 0.1% and about 2%, between about 0.1% and about 1%, between about 0.4% and about 0.6%, between about 0.05% and about 2.5%, between about 0.05% and about 1.5%, between about 0.05% and about 1%, or between about 0.0.5% and about 0.5% by weight of Pisum sativum edible fiber.

It is also within the scope of the invention that the meat structured protein products provided herein comprise small amounts (i.e., 2% or less by weight) of protein, carbohydrate, lipid, or other ingredients derived from animal (e.g., albumin, collagen).

The meat structured protein products provided herein comprise a moisture content (MC) of at least about 30%. A method for determining MC is disclosed in Utility application Ser. No. 14/687,803, filed on Apr. 15, 2015. Without being bound by theory, it is believed that a high MC may prevent the sensation of drying during chewing. In some embodiments, the protein fibrous products provided herein comprise a MC of between about 30% and about 70%, between about 40% and about 60%, between about 33% and about 45%, between about 40% and about 50% between about 30% and about 60%, between about 50% and about 70%, or between about 55% and about 65% by weight. In some embodiments, the post-processed protein fibrous products provided herein comprise a MC of between about 50% and about 90%, between about 60% and about 80%, between about 50% and about 70%, between about 70% and about 80%, between about 75% and about 85%, or between about 65% and about 90% by weight. In some embodiments, the meat structured protein products comprise a similar MC as animal meat.

The meat structured protein products provided herein have a microscopic protein structure similar to that of animal meat. Specifically, the meat structured protein products are made up of protein fibers that are substantially aligned and that form a three-dimensional protein network. Methods for determining the degree of protein fiber alignment and three-dimensional protein network are known in the art and include visual determination based upon photographs and micrographic images, as disclosed in U.S. Utility application Ser. No. 14/687,803, filed on Apr. 15, 2015. Without being bound by theory, it is believed that the microscopic protein structures of the meat structured protein products provided herein impart physical, textural, and sensory properties that are similar to those of cooked animal meat, wherein the aligned and interconnected protein fibers may impart cohesion and firmness, and the open spaces in the protein network may weaken the integrity of the fibrous structures and tenderize the meat structured protein products while also providing pockets for capturing water, carbohydrates, salts, lipids, flavorings, and other materials that are slowly released during chewing to lubricate the shearing process and to impart other meat-like sensory characteristics. In some embodiments, in the meat structured protein products provided herein at least about 55%, at least about 65%, at least about 75%, at least about 85%, or at least about 95% of the protein fibers are substantially aligned.

In some embodiments, the meat structured protein products provided herein have a TPA profile that is similar to that of animal meat. In some embodiments, the meat structured protein products provided herein have a hardness that is similar to that of animal meat. In some embodiments, the meat structured protein products provided herein have a chewiness that is similar to that of animal meat. In some embodiments, the meat structured protein products provided herein have a gumminess that is similar to that of animal meat. In some embodiments, the meat structured protein products provided herein have a springiness that is similar to that of animal meat. In some embodiments, the meat structured protein products provided herein have a cohesiveness that is similar to that of animal meat. In some embodiments, the meat structured protein products provided herein have a resilience that is similar to that of animal meat. In some embodiments, the meat structured protein products provided herein have an average hardness of between about 1 g/mm² and about 500 g/mm², between about 1 g/mm² and about 150 g/mm², between about 10 g/mm² and about 100 g/mm², between about 10 g/mm² and about 50 g/mm², between about 10 g/mm² and about 40 g/mm², between about 10 g/mm² and about 20 g/mm², between about 30 g/mm² and about 50 g/mm², between about 70 g/mm² and 500 g/mm², between about 70 g/mm² and about 200 g/mm², between about 70 g/mm² and about 100 g/mm², between about 100 g/mm² and about 200 g/mm², or between about 200 g/mm² and about 400 g/mm². A method for determining hardness is exemplified in Example 1. In some embodiments, the meat structured protein products have an average chewiness of between about 300 and about 16,000, or between about 300 and about 7,000. In some embodiments, the meat structured protein products have an average gumminess of between about 400 and about 14,000, or between about 444 and about 7,200. In some embodiments, the meat structured protein products have an average springiness of between about 0.3 and about 1.5. In some embodiments, the meat structured protein products have an average cohesiveness of between about 0.39 and about 0.74. In some embodiments, the meat structured protein products have an average resilience of between about 0.21 and about 0.41.

The meat structured protein products provided herein have eating qualities and mouth feels that are substantially similar to those of animal meat. For example, meat structured protein products can have similar moisture, hardness/firmness, and overall texture compared to cooked 80/20 ground beef. The eating qualities and mouth feels of a meat structured protein product can be determined using a panel of human sensory experts.

In some embodiments, the meat structured protein products provided herein are gluten-free. In some embodiments, the meat structured protein products comprise no crosslinking agent that could facilitate filament formation, including but not limited to glucomannan, beta-1,3-glucan, transglutaminase, calcium salts, and magnesium salts. In some embodiments, the meat structured protein products are vegan.

The meat structured protein products provided herein may have any shape and form. Exemplary shapes include but are not limited to crumbles, strips, slabs, steaks, cutlets, patties, nuggets, loafs, tube-like, noodle-like, hat dogs, ground meat, sausages, steaks, filets, roasts, breasts, thighs, wings, meatballs, meatloaf, bacon, strips, fingers nuggets, cutlets, cubes, chunks, and poppers. In some embodiments, the meat structured protein products have the shape of crumbles with dimensions of between about 2 mm and about 25 mm width, between about 2 mm and about 25 mm thickness, and between about 2 mm and about 50 mm length. In some embodiments, the meat structured protein products have the shape of strips with widths of between about 1 cm and about 8 cm and lengths of between about 5 cm and about 30 cm. In some embodiments, the meat structured protein products provided herein have the shape of slabs with widths of between about 30 mm and about 110 cm. In some embodiments, the meat structured protein products provided herein have a thickness of between about 2 mm and about 15 mm, between about 3 mm and about 12 mm, between about 4 mm and about 10 mm, or between about 5 mm and about 8 mm. In some embodiments, the meat structured protein products provided herein have the same thickness across at least about 95%, at least about 90%, at least about 80%, at least about 70%, at least about 60%, or at least about 50% of their length or width. In some embodiments, the meat structured protein products provided herein have the same thickness across no more than about 50%, no more than about 40%, no more than about 30%, no more than about 20%, or no more than about 10% of their width or length.

The meat structured protein products can be sliced, cut, ground, shredded, grated, or otherwise processed, or left unprocessed. Examples of sliced forms include but are not limited to dried meats, cured meats, and sliced lunch meats. The meat structured protein products may also be stuffed into permeable or impermeable casings to form sausages. In some embodiments, the meat structured protein products provided herein are shredded and then bound together, chunked and formed, ground and formed, or chopped and formed according in compliance with Food Standards and Labeling Policy Book (USDA, August 2005) guidelines as pertaining to animal jerky.

In some embodiments, the meat structured protein products provided herein are shaped into patties. The patties can have any shape, including but not limited to square, rectangular, circular, and non-geometric. In some embodiments, the patties are circular and have diameters of between about 80 mm and 100 mm and thicknesses of between about 4 mm and about 85 mm.

The meat structured protein products provided herein may be prepared for human or animal (e.g., farm animals such as pig, cow, and sheep; pets such as cats or dogs) consumption. They may be cooked, partially cooked, or frozen either in uncooked, partially cooked, or cooked state. Cooking may include frying either as sautéing or as deep-frying, baking, smoking, impingement cooking, steaming, and combinations thereof. In some embodiments, the meat structured protein products are used in cooked meals, including but not limited to soups, burritos, chilis, sandwiches, lasagnas, pasta sauces, stews, kebabs, pizza toppings, and meat sticks. In some embodiments, the meat structured protein products are mixed with other protein products, including but not limited to other plant-derived products and/or animal meat. The meat structured protein products can be used for various purposes, including but not limited to feeding; delivery of active ingredients (e.g., vitamins, minerals, nutrients, therapeutics); and analogs for pork, beef, poultry, game, ham, veal, and fish.

### Processes for Producing Meat Structured Protein Products Comprising Microbial Biomass

In another aspect, provided herein are methods for producing the meat structured protein products provided herein.

A variety of production processes may be utilized to produce the meat structured protein products provided herein. Suitable processes generally comprise three steps: (1) initial blending of liquid and dry mixes to form a dough, (2) shearing and heating to denature proteins and to produce aligned protein fibers (e.g., via application of mechanical energy [e.g., spinning, agitating, shaking, shearing, pressure, turbulence, impingement, confluence, beating, friction, wave], radiation energy [e.g., microwave, electromagnetic], thermal energy [e.g., heating, steam texturizing], enzymatic activity [e.g., transglutaminase activity], chemical reagents [e.g., pH adjusting agents, kosmotropic salts, chaotropic salts, gypsum, surfactants, emulsifiers, fatty acids, amino acids]), and (3) setting to fix the fibrous structure (e.g., via rapid temperature and/or pressure change, rapid dehydration, redox, or chemical fixation). Any of these processes may be used to produce the meat structured protein products provided herein.

Preferably, the meat structured protein products provided herein are produced by thermoplastic extrusion. Thermoplastic extrusion (also known as extrusion cooking) is a process wherein a dry mix (e.g., protein, carbohydrate, lipid) and a liquid mix (e.g., water) are fed into a closed barrel. The barrel contains one or more screw shafts that mix the mixture into a dough, convey the dough forward, and impart shear/mechanical pressure. As the dough advances along successive zones of the barrel, pressure and heat are increased, and the dough is converted into a thermoplastic melt in which proteins undergo extensive heat denaturation (causing structural changes such as breakage of hydrophobic and hydrogen bonds, hydrolysis of disulfide bonds, and formation of new covalent and non-covalent bonds). The directional shear force furthermore causes alignment of the high molecular components in the melt, leading to the formation of aligned protein fibers. When the mass is finally pushed through a die, the newly generated structure is fixed in a final protein fibrous product. The protein fibrous product can be formed into any shape by using a suitable die configuration, and can be cut to any size, for example by a blade chopper.

Any physiochemical parameter or extruder configuration parameter may influence the appearance, texture, and properties of the protein fibrous product. The physiochemical parameters include but are not limited to the formulation of the dough (e.g., protein type and content, carbohydrate type and content, lipid type and content, water content, other ingredients) and the cooking temperature. Configuration parameters include but are not limited to the extruder screw and barrel configuration (and resulting screw-induced shear pressure), heating profile across the heating zones, and dimensions of the cooling die. The physiochemical and configuration parameters are not mutually exclusive. Optimal physiological and configuration parameters for the thermoplastic extrusion of the meat structured protein products provided herein can be determined experimentally by titrating a particular parameter against the structure, sensory, and physical chemical characteristics (e.g., microscopic protein structure, sensory panel scores, MC, TPA profile) of the end products, and identifying the setting of the parameter at which the meat structured protein products provided herein are obtained. Such titrations have provided specific physiochemical and configuration parameters suitable for the production of the meat structured protein products provided herein, as exemplified in Examples 1 and 2.

The extruder may be selected from any commercially available extruder. Suitable extruders include but are not limited to the extruders described in U.S. Pat. Nos. 4,600,311; 4,763,569; 4,118,164; and 3,117,006, which are hereby incorporated by reference in their entirety, and commercially available extruders such as the MPF 50/25 (APV Baker Inc., Grand Rapids, Mich.), BC-72 (Clextral, Inc., Tampa, Fla.), TX-57 (Wenger Manufacturing, Inc., Sabetha, Kans.), TX-168 (Wenger Manufacturing, Inc., Sabetha, Kans.), and TX-52 models (Wenger Manufacturing, Inc., Sabetha, Kans.). In some embodiments, the temperature of each successive heating zone of the extruder barrel exceeds the temperature of the previous heating zone by between about 10° C. and about 70° C. Heating can be mechanical heating (i.e., heat generated by the turning of extruder screws), electrical heating, or a combination of mechanical and electrical heating. In preferred embodiments, heating is about 10% mechanical heating and about 90% electrical heating. In preferred embodiments, the temperature of the thermoplastic melt at the point of exit from the last heating zone is between about 95° C. and about 180° C., between about 110° C. and about 165° C., between about 115° C. and about 145° C., or between about 115° C. and about 135° C. In some embodiments, the pressure in the die is between about 5 psi and about 500 psi, between about 10 psi and about 300 psi, between about 30 psi and about 200 psi, between about 50 psi and about 250 psi, between about 70 psi and about 150 psi, between about 100 psi and about 200 psi, between about 150 psi and about 300 psi, between about 200 psi and about 300 psi, between about 250 and 300 psi, between about 300 psi and about 500 psi, or between about 10 psi and 25 psi.

The meat structured protein products provided herein are generated by thermoplastic extrusion or other production process wherein the doughs comprise at least about 2% by weight of microbial biomass. In some embodiments, the doughs comprise between about 2% and about 70%, between about 5% and about 70%, between about 10% and about 70%, between about 20% and about 70%, between about 30% and about 60%, between about 2% and about 10%, between about 3% and about 9%, between about 4% and about 8%, between about 4% and about 7%, between about 2% and about 15%, between about 3% and about 12%, between about 4% and about 10%, between about 5% and about 15%, between about 2% and about 30%, between about 3% and about 30%, between about 4% and about 30%, between about 5% and about 30%, between about 10% and about 20%, between about 20% and about 30%, between about 30% and about 40%, between about 40% and about 50%, between about 50% and about 60%, between about 60% and about 70%, between about 10% and about 30%, between about 20% and about 40%, between about 30% and about 50%, between about 40% and about 60%, between about 50% and about 70%, between about 10% and about 40%, between about 20% and about 50%, between about 30% and about 60%, between about 40% and about 70%, between about 10% and about 50%, between about 20% and about 60%, or between about 30% and about 70% by weight of microbial biomass. In preferred embodiments, the doughs comprise at least about 2% by weight of yeast biomass. In other preferred embodiments, the doughs comprise at least about 2% by weight of algae biomass. In yet other preferred embodiments, the doughs comprise at least about 2% by weight of bacteria biomass. The microbial biomass may be added to the dough in any form, including but not limited to dry powder, liquid, slurry, and mixtures thereof. In some embodiments, the doughs comprise at least some of the microbial biomass in the form of live or dead whole cells. In some embodiments, the doughs comprise at least about 2% by weight of whole cell microbes. In some embodiments at least about 10%, at least about 20%, at least about 50%, at least about 75% or at least about 95% of the microbial biomass in the doughs is in the form of whole cell microbes.

The meat structured protein products provided herein are generated by thermoplastic extrusion or other production process wherein the doughs may comprise at least about 1% by weight of microbial protein. The microbial protein is comprised of a mixture of polypeptide molecules having various amino acid sequences, and of a mixture of intracellular protein and cell envelope protein. In some embodiments, the microbial protein also comprises extracellular protein. In some embodiments, the microbial protein has an EAS of at least about 90. In some embodiments, the microbial protein has a PDCAAS of at least about 0.75. In some embodiments, the meat structured protein products comprise between about 1% and about 70%, between about 5% and about 70%, between about 10% and about 70%, between about 20% and about 70%, between about 30% and about 60%, between about 1% and about 10%, between about 2% and about 9%, between about 3% and about 8%, between about 4% and about 7%, between about 5% and about 6%, between about 1% and about 15%, between about 3% and about 12%, between about 4% and about 10%, between about 5% and about 15%, between about 2% and about 30%, between about 3% and about 30%, between about 4% and about 30%, between about 5% and about 30%, between about 10% and about 20%, between about 20% and about 30%, between about 30% and about 40%, between about 40% and about 50%, between about 50% and about 60%, between about 60% and about 70%, between about 10% and about 30%, between about 20% and about 40%, between about 30% and about 50%, between about 40% and about 60%, between about 50% and about 70%, between about 10% and about 40%, between about 20% and about 50%, between about 30% and about 60%, between about 40% and about 70%, between about 10% and about 50%, between about 20% and about 60%, or between about 30% and about 70% by weight of microbial protein. In preferred embodiments, the meat structured protein products comprise at least about 1% by weight of yeast protein. In other preferred embodiments, the meat structured protein products comprise at least about 1% by weight of algae protein. In yet other preferred embodiments, the meat structured protein products comprise at least about 1% by weight of bacteria protein.

The meat structured protein products provided herein are generated by thermoplastic extrusion or other production process wherein the doughs may comprise at least about 0.5% by weight of microbial carbohydrate. The microbial carbohydrate is comprised of a mixture of carbohydrate molecules, and of a mixture of intracellular carbohydrate and cell envelope carbohydrate. In some embodiments, the microbial carbohydrate also comprises extracellular carbohydrate. In some embodiments, the meat structured protein products comprise between about 0.5% and about 10%, between about 1% and about 8%, between about 2% and about 6%, between about 3% and about 5%, or between about 1.5% and about 3.5% by weight of microbial carbohydrate. In preferred embodiments, the meat structured protein products comprise at least about 0.5% by weight of yeast carbohydrate. In other preferred embodiments, the meat structured protein products comprise at least about 0.5% by weight of algae carbohydrate. In yet other preferred embodiments, the meat structured protein products comprise at least about 0.5% by weight of bacteria carbohydrate.

The meat structured protein products provided herein are generated by thermoplastic extrusion or other production process wherein the doughs may comprise at least about 0.1% by weight of microbial lipid. The microbial lipid is comprised of a mixture of lipid molecules, and of a mixture of intracellular lipid and cell envelope lipid. In some embodiments, the microbial lipid also comprises extracellular lipid. In some embodiments, the meat structured protein products comprise between about 0.1% and about 10%, between about 0.2% and about 8%, between about 0.3% and about 6%, between about 0.4% and about 5%, or between about 0.5% and about 4% by weight of microbial lipid. In preferred embodiments, the meat structured protein products comprise at least about 0.1% by weight of yeast lipid. In other preferred embodiments, the meat structured protein products comprise at least about 0.1% by weight of algae lipid. In yet other preferred embodiments, the meat structured protein products comprise at least about 0.1% by weight of bacteria lipid.

The dough may further comprise other microbial compounds.

The microbial protein, microbial carbohydrate, microbial lipid, or other microbial compounds comprised in the microbial biomass, doughs, and meat structured protein products may be derived from a single or from multiple natural and/or modified microbial sources. The microbial protein, microbial carbohydrate, microbial lipid, or other microbial compounds may be native or not native to the microbial source and/or sources from which the microbial biomass is derived. When native, the microbial protein, microbial carbohydrate, microbial lipid, or other microbial compounds may be produced when the natural and/or modified natural source or sources are grown under native conditions or under controlled conditions. When not native, the microbial protein, microbial carbohydrate, microbial lipid, or other microbial compounds may be native to another organism (e.g., another microbe, plant, animal) but may be produced by the microbial source or sources because the microbial source or sources are modified microbial source or sources (e.g., mutated or genetically engineered microbial source or sources). Alternatively, when not native, the microbial protein, microbial carbohydrate, microbial lipid, or other microbial compounds may be modified versions of naturally occurring protein, carbohydrate, lipid, or other compounds that are either native to the microbial source or sources from which the microbial biomass is derived or native to another organism (e.g. another microbe, plant, animal), or they are not found in nature.

The doughs may also comprise non-microbial ingredients. The non-microbial ingredients can be native to one or more non-microbial sources; produced by one or more modified non-microbial sources; produced by one or more non-microbial sources or modified natural non-microbial sources under controlled conditions, or produced synthetically. In some embodiments, the doughs comprise between about 5% and about 68% by weight of non-microbial protein, between about 0.5% and about 10% by weight of non-microbial lipid, between about 0.5% and about 20% by weight of non-microbial carbohydrate. In some embodiments, the doughs comprise a similar total protein content (i.e., protein from microbial and non-microbial sources) as animal meat. In some embodiments, the doughs comprise between about 30% and about 50% by weight of total protein, between about 1% and about 5% by weight of total carbohydrate, between about 0.1% and about 2% by weight of total edible fiber, between about 1% and about 5% by weight of total lipid, and between about 40% and about 60% by weight of water. In some embodiments, the doughs comprise less than about 2%, less than about 1%, less than about 0.5%, less than about 0.25%, less than about 0.1%, or less than about 0.005% by weight of saturated fat. Since the doughs provided herein ultimately result in the meat structured protein products provided herein, the same protein, carbohydrate, lipid, and other ingredients as described in the composition of the meat structured protein products can be utilized in making the doughs. The non-microbial protein may be added to the dough in any form, including but not limited to protein concentrate, protein isolate, or protein flour; natured, denatured, or renatured protein; dried, spray dried, or not dried protein; enzymatically treated or untreated protein; and mixtures thereof. The non-microbial protein added to the dough may consist of particles of any size, and may be pure or mixed with other components (e.g., other plant source components). In some embodiments, the non-microbial protein is added to the dough in a preparation that has an alkaline pH.

The dough typically comprises at least some non-microbial protein derived from multicellular plant. In some such embodiments, the doughs comprise between about 5% and about 68%, between about 20% and about 60%, between about 30% and about 50%, between about 34% and about 50%, between about 30% and about 60%, between about 40% and about 68%, between about 40% and about 60%, between about 5% and about 35%, between about 10% and about 30%, between about 15% and about 25%, between about 17% and about 25%, between about 15% and about 30%, between about 20% and about 35%, or between about 20% and about 30% by weight of multicellular plant protein. In some such embodiments, the dough comprises pea protein. The pea protein may be added to the dough in the form of pea protein concentrate, pea protein isolate, pea flour, or mixtures thereof, or in any other form. In some embodiments, the doughs comprise between about 5% and about 68%, between about 20% and about 60%, between about 30% and about 50%, between about 40% and about 60%, or between about 34% and about 46% by weight of Pisum sativum protein.

In some embodiments, the doughs comprise lipid derived from multicellular plant. In some embodiments, the doughs comprise between about 0.5% and about 10%, between about 2% and about 8%, between about 2% and about 6%, between about 2% and about 5%, between about 2% and about 4%, between about 3% and about 6%, between about 3% and about 5%, between about 3% and about 4%, between about 4% and about 5%, between about 5% and about 10%, between about 0.5% and about 5%, between about 1% and about 4%, between about 1% and about 3%, between about 1% and about 2%, between about 1.5% and about 3%, between about 1.5% and about 2.5%, between about 1.5% and about 2%, between about 2% and about 2.5%, or between about 2.5% and about 5% by weight of multicellular plant lipid.

In some embodiments, the doughs comprise carbohydrate from multicellular plant. In some embodiments, the doughs comprise between about 0.5% and about 20%, between about 1% and about 10%, between about 2% and about 9%, between about 1% and about 5%, between about 2% and about 4%, between about 1% and about 3%, between about 5% and about 15%, between about 0.5% and about 10%, between about 0.5% and about 5%, between about 0.5% and about 2.5%, between about 0.5% and about 1.5%, between about 1% and about 3%, or between about 2.5% and about 7.5% by weight of multicellular plant carbohydrate. In some embodiments, the doughs comprise between about 0.1% and about 3%, between about 1% and about 3%, between about 2% and about 3%, 0.1% to about 1.5%, between about 0.5% and about 1.5%, or between about 1% and about 1.5% by weight of multicellular plant starch. In some embodiments, the doughs comprise pea starch. In some such embodiments, the doughs comprise between about 0.1% and about 3%, between about 1% and about 3%, between about 2% and about 3%, between about 0.1% and about 1.5%, between about 0.5% and about 1.5%, or between about 1% and about 1.5% by weight of Pisum sativum starch. In some embodiments, the doughs comprise between about 0.1% and about 5%, between about 0.1% and about 3%, between about 0.1% and about 2%, between about 0.1% and about 1%, between about 0.4% and about 0.6%, between about 0.05% and about 2.5%, between about 0.05% and about 1.5%, between about 0.05% and about 1%, or between about 0.0.5% and about 0.5% by weight of multicellular plant edible fiber. In some embodiments, the doughs comprise edible pea fiber. In some such embodiments, the doughs comprise between 0.1% and about 5%, between about 0.1% and about 3%, between about 0.1% and about 2%, between about 0.1% and about 1%, between about 0.4% and about 0.6%, between about 0.05% and about 2.5%, between about 0.05% and about 1.5%, between about 0.05% and about 1%, or between about 0.0.5% and about 0.5% by weight of Pisum sativum edible fiber.

In some embodiments, the dough comprises 5% or less by weight of one or more ingredients derived from animal. Without being bound by theory, it is believed that such small amount of an animal ingredient may improve the texture, color, aroma, or taste of certain embodiments of the meat structured protein products provided herein. Examples of suitable animal ingredients include but are not limited to animal meat and components thereof, including interstitial fluid extracted from animal meat.

The doughs further comprise a MC of at least 30% by weight. In some embodiments, the dough comprises a MC of between about 30% and about 70%, between about 40% and about 60%, between about 33% and about 45%, between about 40% and about 50% between about 30% and about 60%, between about 50% and about 70%, or between about 55% and about 65% by weight.

### Processes for Producing Microbial Biomass

The process of preparing microbial biomass may comprise any of the following steps, in or out of order: a) selecting one or more suitable microbes; b) growing the microbes; c) harvesting and optionally washing the microbes; d) optionally dissociating the microbes; g) optionally lysing the microbes; and h) optionally further treating the biomass.

Selecting one or more suitable microbes may entail an assessment of the food value and the production process compatibility of the microbes. Such assessment may include but is not limited to assessment of the type of carbon source used by the microbes; the safety of the microbes; the growth characteristics of the microbes; the ability to separate desired biomass from undesired components or toxic substances; and the nutritional value of the microbes (e.g., protein content, amino acid composition, content of essential amino acids, content of sulfur-containing amino acids, EAS, PDCAAS, lipid content, proportion of fatty acids/sterols/phospholipids, total nitrogen content, proportion of nucleic acid/amino acid/purine bases/pyrimidine bases, water content, fiber content, major mineral [e.g., Na, K, Mg, Ca, Cl] content, trace element [e.g., Mn, Zn, Cu, Fe, Co, Mo, As, Pb, Hg] content, carbohydrate content, and vitamin content).

Growing the microbes may entail growing the microbes under native conditions or under controlled conditions. The microbes may be grown in fermentation or non-fermentation cultures (e.g., in aqueous liquid contained in a fermenter vessel, the liquid comprising assimilable nitrogen and carbon sources; fermentation can be mixed and/or aerated during fermentation, and if necessary depelleting can be performed); to exponential growth or stationary phase; to low or high (OD600>1) density; in batch, fed-batch, continuous, or recycling mode. Alternatively, waste streams can be obtained from commercial facilities, including but not limited to breweries, wine production companies, and biofuel companies that use microbes as fermentation organisms.

In simplest embodiments, the microbes are used as culture broths without further preparation. Alternatively, the microbes are harvested, for example by sedimentation, and optionally washed (e.g., by single wash, multiple washes, counter-current washing, continuous flow centrifugation, or tangential flow flirtation [TFF]). The sedimented microbes are then typically resuspended in a suitable solution (e.g., water) to form a slurry. Alternatively, the sedimented microbes may be dried, using for example a freeze or spray dryer, rotary vacuum, centrifuge, lyophylizer, or evaporator, to obtain clumped or not clumped microbial preparations. The solution used to resuspend the microbes may contain another compound, for example a compound that confers a particular buffering capacity or pH on the solution (i.e., a buffering or pH adjusting agent). Without being bound by theory, it is believed that the presence of a buffering or pH adjusting agent may cause the slurry to have properties that are more advantageous for the production of meat structured protein products as described herein, may protect the integrity of the microbial cells, or may prevent contamination or undesired bacterial growth in the microbial biomass. In some embodiments, the microbial biomass is resuspended in a solution comprising calcium hydroxide, wherein the resulting slurry has a pH of between about 7 and about 8.5. In other embodiments, the microbial biomass is resuspended in a solution comprising hydrochloric acid, wherein the resulting slurry has a pH of between about 3 and about 7. In yet other embodiments, the microbial biomass is resuspended in a solution comprising hydrochloric acid, wherein the resulting slurry has a pH of less than about 3.

The microbes may optionally be dissociated, for example, by grinding (e.g., using Waring Blender, Polytron, mortar and pestle), shaking, centrifuging, tituration, or shearing. A suitable example of a dissociation method is cold pressing, in which the microbes are gently ground into pulp that is then squeezed with a powerful press to release fluid.

The microbes may optionally be lysed. Lysing can be accomplished using standard methods, such as, for example, thermal denaturation (using heat from electrical or mechanical energy), mechanical shearing (e.g., by homogenizing in a French press, bead milling, microfluidizing, sonicating, osmotic shocking), electrical shock (e.g., electroporating), chemical cell wall disruption (e.g., using acid, base, or solvents), enzymatic degradation, or combinations thereof. In one embodiment the microbial cells are lysed by treatment with high salt and/or acids (e.g., hydrochloric acid; the biomass preparation can be subsequently neutralized again with bases [e.g., sodium hydroxide, potassium hydroxide, calcium hydroxide]). In another embodiment, the microbes are lysed by extruding the microbial slurry under high pressure and/or high temperature (e.g., using variations in paddle orientation, screw speed, heat, density of materials, back pressure, or flow rates). Without being bound by theory, it is believed that lysing microbes not prior to but during the food production process (e.g., during extrusion) may reduce levels of monosodium glutamate (MSG) or free glutamate in the food products because the microbial proteases are immediately inactivated (e.g., by mechanical shear or cooking temperature) and cannot degrade proteins into free amino acids.

Lysates may optionally be fractionated (e.g., subcellular components, soluble protein, soluble carbohydrate, soluble lipid, biopolymers, dolichol, fatty acids, membrane fractions, protein fractions, molecular weight fractions, isoelectric point fractions, density fractions), using, for example, centrifugation, standard chromatography (e.g., reverse-phase, dialysis, affinity, ion exchange, size exclusion), precipitation (e.g., ammonium sulfate precipitation), crystallization, solvent extraction, pH isoelectric focusing, and denaturation. In some embodiments, fractionation methods are employed that do not denature protein. One such method is TFF. A suitable fractionation strategy using TFF could employ a first set of filters with a 0.1 to 0.45 um size cutoff to remove large components (e.g., intact microbial cells, microbial cell debris, large macromolecules [e.g., starches], molecular aggregates). The permeate of such first filtration may be fed to a second filter system that has a defined molecular weight cutoff (e.g., larger than about 10 kDa, larger than about 30 kDa, larger than about 50 kDa, larger than about 70 kDa, larger than about 100 kDa, larger than about 200 kDa, larger than about 300 kDa, large than about 500 kDa, larger than about 750 kDa) to remove smaller sized components (e.g., molecules that confer bitter taste and/or color, alkaloids, free amino acids, di- and tri-amino peptides). The retentate of such second filtration step would mostly comprise proteins of chosen minimal size.

The microbial biomass may optionally be treated further to maintain purity and/or freshness, employing standard food chemistry or shelf life preservation methods, including but not limited to centrifugation; enzymatic break down; enzymatic alteration (e.g., treatment with zymolyase or enzymes with similar beta-1,3-glucanase and beta-1,3-glucan liminaripentaosehydrolase activities, which may be immobilized on a solid phase [e.g., beads] or suspended in solution); partial or full dehydration (e.g., using mechanical means such as filtration, centrifugation, settling, drying); hydration (e.g., as described above); extraction (e.g., solid phase extraction, liquid-liquid extraction); buffering; dialysis; precipitation, crystallization; pH isoelectric focusing; denaturing; chromatography (e.g., reverse-phase, affinity, displacement, ion exchange, liquid, size-exclusion chromatography); alkaline treatment (e.g., using potassium hydroxide, sodium hydroxide, calcium hydroxide); oxidation (e.g., using hydrogen peroxide); anti-oxidation (e.g., using ascorbic acid); reduction; addition of scavenging agents (e.g., charcoal); removal of RNA by physical (e.g., heat), chemical, and/or enzymatic treatment; heat treating, pasteurizing, or killing cells or otherwise (e.g., chemically) inactivating undesirable proteins or enzymes.

The microbial biomass typically comprises microbial proteins, microbial lipids, microbial carbohydrates, and other microbial compounds, that are either native to the microbes or not native to the microbes but are produced by modified microbes. Examples of such microbial protein, microbial carbohydrate, microbial lipid, or other microbial compounds include but are not limited to maltodextrin, inulin, fructo oligosaccharides, pectin, structural heteropolysaccharide, carboxymethyl cellulose, cornstarch, guar gum, tara gum, xanth gum, glucose, lactose, monosaccharides, disaccharides, oligosaccharides, polysaccharides, sugars, starches, glycogen, chitin, cellulose, ribose, deoxyribose, inositol, glucosamine, lyxose, ribulose, xylulose, galactose, galactolipids, glycoproteins, mannose, trehalose, fructose, pyranose, furanose, maltose, fats, monglycerides, diglycerides, triglycerides, phospholipids, membrane lipids, fatty acids, free fatty acids, conjugated fatty acids, omega fatty acids, omega-3-fatty acids, omega-6-fatty acids, omega-7-fatty acids oils, omega-9-fatty acids, cholesterol, prenol lipis, sterols, fat soluble vitamins, fat soluble minerals, fat soluble compounds, fat soluble peptides and proteins, sterol containing metabolites, terpene compounds, monoterpenes diterpenes, sesquiterpenes, triterpenes, cholesterol, prenol lipids, saccharolipids, polyketides, membranes, wax esters, eicosanoids, arachidonic acid, eicosapentaenoic acid, prostagandins, leukotrienes, thromboxanes, docosahexaenoic acid, coenzyme A, coenzymes, carnitines, ethanolamines, N-acylethanolamines, cannabinoids, anandamide, glycerol, mon-glycerol, di-glyceride, tri-glyceride, esters of glycerol, sugar, sugar residues, glycerolipids, glycerophospholipids, phospholipids, phosphatidylcholine, lecithin, phosphatidylethanolamine, phosphatidylserine, phosphatidylinositol, inositol, phosphatidic acid, glycerophospholipids, sphingolipids, ceramids, phosphosphingolipids, glycosphingolipids, sphingomyelin, sphingosine, ceramide phosphocholines, ceramide phosphoethanolamines, phytoceramide phosphoinositols, cerebrosides, gangliosides, prenol lipids, glucosamine, lipopolysaccharides, linolenic acid, linoleic acid, eicosapentaenoic acid, docosahexaenoic acid, partially hydrogenated vegetable oils, polyunsaturated fats, C18-/C21-/C19-carbon containing steroids, isoflavones, phytoestrogens, progestogens, glucocorticoids, mineralocorticoids, secosteroids, vitamin D, phytosterols, beta-sitosterol, stigmasterol, brassicasterol, ergosterol, ergosterol pathway proteins, squalane, mevalonate, terpenes, carotenoids, vitamin A, quinones, hydroquinones, vitamin E, vitamin K, ubiquinones, polyprenols, bactoprenols, dolichols, oxysterols, cortisol, LXR agonists and antagonists, acyl-carnitines, isoprenoids, isoprenes, isopentenyl pyrophosphate, dimethylallyl pyrophosphate, lanosterol, chitin, peptidoglycan, cardiolipins, endocannabinoids, eicosanoids, lipoxins, resolvins, leukotrienes, prostaglandins, thromboxanes, essential oils, non-essential oils, erythromycins, tetracyclines, avermectins, epothilones, membranes, thylakoid membranes, amino acids, essential amino acids, non-essential amino acids, alpha-, beta, gamma, delta-amino acids, arginine, histidine, lysine, aspartic acid, aspartate, aspartamine, glutamic acid, glutamine, glutamate, serine, threonine, cysteine, selenocysteine, glycine, proline, alanine, valine, isoleucine, leucine, methionine, phenylalanine, tyrosine, tryptophan, pyrrolysine, lysinoalanine, chemically altered versions of all compounds above, DNA, deoxyribonucleicc acid, RNA, ribonucleic acid, tRNA, transfer RNA, rRNA, ribosomal RNA, hydroxyproline, proteinogenic amino acids, hypusine, lanthionine, 2-aminoisobytyric acid, gamma-aminobutyric acid, ornithine, citruline, pantothenic acid, taurine, catecholamines, porphyrins, hemoglobin, leghemoglobin, phenylpropanoids, canavanine, mimosine, oxaloacetate, alphaketoglutarate, homocysteine, s-adenosyl-methionine, 2-aminoisobutyric acid, lanthionine, alamethicin, 1-aminocyclopropane-1-carboxylic acid, ethylene, pyruvate, citrate, oxaloacetate, succinyl-CoA, succinate, fumarate, malate, isocitrate, palmitic acid, pyrrolysine, photoreactive amino acids, photoleucine, photomethionine, humectants (e.g, sorbitol, polyethylene glycol, xylitol), pH adjusting agents, peptides, resveratrol, nucleic acids (e.g., DNA, RNA), and tannins (e.g., ellagic tannins, gallic tannins, profisetinidin tannins, tannins from green tea leaves, ellagic tannins from roasted oak wood, proanthocyanidin tannins from grape seeds, proanthocyanidin tannins from grape skin, proanthocyanidin tannins from aromatic grape skin, tannins from sangre de drago), microbial enzymes, microbial metabolites, recombinant products, microbial modified compounds (e.g., hydroxylation, dehydrogenation, reduction, side chain degradation, lactone formation, aromatization, isomerization, epoxidation, hydrolysis, esterification, halogenation), collagen-like proteins, and fermented plant products, plant collagen-like proteins, actin, SOD, catalase, catecholamines, terpines, transglutaminase, hydrolase, peroxidase, and oxidoreductase.

The microbial protein, microbial carbohydrate, microbial lipid, or other microbial compounds that may be comprised in the microbial biomass may be native to multicellular plants. Examples of such multicellular plants include but are not limited to potato, cassava, sweet potato, taro, carrot, beetroot, onion, shallot, garlic, bamboo shoot, swede, turnip, broccoli, brussels sprout, bok choy, cabbage, cauliflower, kale, lettuce, silverbeet, spinach, snow pea, tomato, celery, sprout, zucchini, squash, avocado, capsicum, eggplant, mushroom, cucumber, okra, pumpkin, green pea, green bean, soy, yellow pea, chickpea, nut, lupin, red kidney bean, soybean, lima bean, cannellini bean, lentil, split pea, tofu, wheat, maize, oat, rye, barley, rice, millet, quinoa, corn, buckwheat, sorghum, triticale, rye, semolina, bran, cottonseed, manioc, yucca, tapioca, sunflower, amaranth, arrowroot, canna, rape, hemp, camelina, mustard seed, alfalfa, peanut, channa (garbanzo), rapeseed (canola), fava bean, cereal plants, legume plants, vegetable plants, nut plants, fruit plants, olive, palm, plant seeds, walnut, peanut, soya, linseed, hempseed, pumpkin seed, sunflower seed, chia seed, leafy vegetables, herbal plants, flax seed, marigold, turmeric, paprika, betel, coriander, curry, garlic, green garlic, green chili, ginger, green ginger, pepper, green pepper, black pepper, white pepper, onion, coriander seed, cumin seed, fenugreek, coffee, fennel seed, ajowan seed, calamus, cardamom, cassia bark, celery seed, cinnamon bark, cinnamon leaf, clove bud, clove leaf, curcuma aromatica, davana, dill seed, fennel seed, galangal, ginger, Java galangal, juniper berry, lemon grass, mace, nutmeg, olibanum, palmarosa, parsley seed, vetiver, rosemary, capsicum, parsley seed, cassia bark, and vanilla.

### Microbes

Suitable microbes from which microbial biomass can be prepared include any eukaryotic or prokaryotic unicellular organism. Suitable microbes include but are not limited to fungi, algae, and bacteria.

Fungi can use a large number of complex growth substances such as cellulose and starch, and are easily recovered by simple filtration. The use of yeast in food production (e.g., for fermentation, flavoring, and nutrition) is well accepted. Yeast protein has an EAS of 132 and a PCAAS of 1.0. In one embodiment, yeast is used directly from a fermentation broth. In some such embodiments, the fermentation broth has an OD600 nm of greater than 1.0. Examples of suitable fungi include but are not limited to Candida etchellsii, Candida guilliermondii, Candida humilis, Candida utilis, Candida versatilis, Debaryomyces hansenii, Mucorales, Fusarium, Fusarium venenatum, Fusarium graminearum, Deuteromycota, Kluyveromyces lactis, Kluyveromyces marxianus, Kluyveromyces thermotolerans, Pichia pastoris, Rhodotorula sp., Saccharomyces bayanus, Saccharomyces beticus, Saccharomyces cerevisiae, Saccharomyces chevalieri, Saccharomyces diastaticus, Saccharomyces ellipsoideus, Saccharomyces exiguus, Saccharomyces florentinus, Saccharomyces pastorianus, Saccharomyces pombe, Saccharomyces sake, Saccharomyces uvarum, Sporidiobolus johnsonii, Sporidiobolus salmonicolor, Sporobolomyces roseus, Xanthophyllomyces dendrorhous, Yarrowia lipolytica, Zygosaccharomyces rouxii, and derivatives and crosses thereof.

Algae comprise high levels of nutritionally valuable constituents (including but not limited to polyunsaturated fatty acids, proteins, enzymes, vitamins, minerals, trace elements, and antioxidants). The use of certain algae in food production is well accepted. Algae may be grown in bioreactors, fermenters, open ponds, or other, and can be fed a carbon source or allowed to utilize CO2 and light energy. They may comprise agar and alginates in their cell walls that may provide superior thickeners, binders, vegan substitutes for gelatins (binders), and emulsifiers in the meat structured protein products provided herein, as well as natural carotenoids like astaxanthin and beta-carotene as coloring agents. Examples of suitable algae include but are not limited to viridiplantae, stramenopiles, rhodophyta, chlorophyta, PX, bangiophyceae, florideohpyceae, trebouxiophyceae, phaeophyceae, palmariales, gigartinales, bangiales, gigartinales, Chlorella, Laminaria japonica, Laminaria saccharina, Laminaria digitata, Macrocystis pyrifera, Alaria marginata, Ascophyllum nodosum, Crypthecodinium cohnii, Lentinus edodes, Ecklonia sp., Palmaria palmata, Gloiopeltis furcata, Porphyra columbina, Gigartina skottsbergii, Gracilaria lichenoides, Chondrus crispus, Gigartina bursa-pastoris, Rhodophyta, Porphyridium cruentum (P. purpureum), Porphyridium aerugineum, Rhodella maculate, Rhodella reticulata, Rhodella violacea, Palmaria palmata, Rhodymenia palmata, Porphyra tenera, Porphyra columbina, Gigartina skotsbergii, Chondrus crispus, Gracilaria lichenoides, Gracilaria bursa pastoris and derivatives and crosses thereof.

Bacteria are a particularly suitable source of microbial biomass because their growth rates and biomass yields are greater than those of most other microorganisms, and because their amino acid profiles are balanced and their sulfur-containing amino acid and lysine concentrations are high. Examples of suitable bacteria include but are not limited to Firmicutes, Oscillatoriales, Oscillatoriophcideae, Bacillales, Bacillus coagulans, Lactobacillales, Lactobacillaceae, Lactobacillus sakei, Lactobacillus plantarum, Lactobacillus salivarius, Lactobacillus acidophilus, Lactobacillus reuteri, Cacillaceae, Arthrospira, Arthrospira platensis, Arthrospira maxima, and derivatives and crosses thereof.

Microbes may be obtained in raw or in powdered form from a variety of sources including but not limited to brewery stores, commercial cell banks (e.g., ATCC [American Type Culture Collection], collaborative sources, algae culture collections such as UTEX), nature (e.g., soil, lakes, oceans, rocks, gardens, forests, animals, plants), and commercial organizations (e.g., Aliexpress, Kalyx, NutriCargo).

Modified microbes may be obtained from a variety of sources including but not limited to brewery stores and commercial cell banks (e.g., ATCC, collaborative sources), or can be generated from microbes by methods known in the art, including selection, mutation, or gene manipulation. Selection generally involves continuous multiplication and steady increase in dilution rates under selective pressure. Mutation generally involves selection after exposure to mutagenic agents. Gene manipulation generally involves genetic engineering (e.g., gene splicing, insertion of deletions or modifications by homologous recombination) of target genes.

A modified microbe may produce a non-native protein, carbohydrate, lipid, or other compound, or produce a non-native amount of a native protein, carbohydrate, lipid, or other compound. In some embodiments, the modified microbe expresses higher or lower levels of a native protein or metabolic pathway compound. In other such embodiments, the modified microbe expresses one or more novel recombinant proteins, RNAs, or metabolic pathway components derived from another microbe or from a plant, algae, animal, or fungus. In other embodiments, the modified microbe has an increased nutraceutical content compared to its native state. In yet other embodiments, the modified microbe has more favorable growth and production characteristics compared to its native state. In some such embodiments, the modified microbe has an increased specific growth rate compared to its native state. In other such embodiments, the modified microbe can utilize a different carbon source than its native state.

Modified microbes may produce protein, carbohydrate, lipid, or other compounds that are native to plant. Suitable plants include but are not limited to potato, cassava, sweet potato, taro, carrot, beetroot, onion, shallot, garlic, bamboo shoot, swede, turnip, broccoli, brussels sprout, bok choy, cabbage, cauliflower, kale, lettuce, silverbeet, spinach, snow pea, tomato, celery, sprout, zucchini, squash, avocado, capsicum, eggplant, mushroom, cucumber, okra, pumpkin, green pea, green bean, soy, yellow pea, chickpea, nut, lupin, red kidney bean, soybean, lima bean, cannellini bean, lentil, split pea, tofu, wheat, maize, oat, rye, barley, rice, millet, quinoa, corn, buckwheat, sorghum, triticale, rye, semolina, bran, cottonseed, manioc, yucca, tapioca, sunflower, amaranth, arrowroot, canna, rape, hemp, camelina, mustard seed, alfalfa, peanut, channa (garbanzo), rapeseed (canola), fava bean, cereal plants, legume plants, vegetable plants, nut plants, fruit plants, olive, palm, plant seeds, walnut, peanut, soya, linseed, hempseed, pumpkin seed, sunflower seed, chia seed, leafy vegetables, herbal plants, flax seed, marigold, turmeric, paprika, betel, coriander, curry, garlic, green garlic, green chili, ginger, green ginger, pepper, green pepper, black pepper, white pepper, onion, coriander seed, cumin seed, fenugreek, coffee, fennel seed, ajowan seed, calamus, cardamom, cassia bark, celery seed, cinnamon bark, cinnamon leaf, clove bud, clove leaf, curcuma aromatica, davana, dill seed, fennel seed, galangal, ginger, Java galangal, juniper berry, lemon grass, mace, nutmeg, olibanum, palmarosa, parsley seed, vetiver, rosemary, capsicum, parsley seed, cassia bark, and vanilla.

In some embodiments, the genetically modified microbe has an increased overall protein content compared to its native state. In other embodiments, the protein content of a genetically modified microbe has an increased EAS or PDCAAS compared to that of the microbe's native state. In yet other embodiments, the genetically modified microbe has an increased nutraceutical content compared to its native state.

In some embodiments, the genetically modified microbe comprises increased protein crosslinking activity compared to its native state. Increased protein crosslinking activity may be due to a variety of reasons including but not limited to production of a not native crosslinking enzyme, increased production of a native crosslinking enzyme, decreased activity of an inhibitor of a crosslinking enzyme, or increased levels of a cofactor of a crosslinking enzyme. Without being bound by theory, it is believed that increased crosslinking activity can contribute to the creation of three-dimensional protein fiber networks in the food products provided herein akin to those present in animal meat. Examples of crosslinking enzymes include but are not limited to enzymes that catalyze direct covalent binding between polypeptide chains, such as hydrolases (EC 3) and transferases (EC 2; e.g., transglutaminases that introduce glutamyl-lysyl isopeptide bonds between target proteins [EC 2.3.2.13], peptidases such as sortases that introduce peptide bonds between polypeptide fragments [EC 3.4.x]), and enzymes that catalyze covalent bonding via reactive species (EC 1; e.g., lysyl oxidases [EC 1.4.3.13], glucose oxidases, sulfhydryl (or thiol) oxidases, tyrosinases [EC 1.14.18.1], laccases [EC 1.10.3.2], peroxidases [EC 1.11.1.x], lipoxygenases [EC 1.13.11]). In some embodiments, the crosslinking enzyme has a low degree of specificity towards the amino acid sequence of its target proteins. Low specificity promotes the formation of more extensive protein networks. An example of a suitable low specificity crosslinking enzyme is microbial transglutaminase from S. mobaraensis, which forms isopeptide crosslinks between glutamine and lysine residues of proteins. Additional examples include but are not limited to oxidoreductases. In other embodiments, the crosslinking enzyme has a high degree of specificity towards the amino acid sequence of its target proteins. An example of a suitable high specificity crosslinking enzyme is sortase SrtA from S. aureus.

A genetically modified microbe may have more favorable growth and production characteristics than its native state. In some embodiments, the genetically modified microbe has an increased specific growth rate compared to its native state. In other embodiments, the genetically modified microbe can utilize a different carbon source than its native state.

### Other Microbial Compounds and Other Non-Microbial Ingredients

The doughs, meat structured protein products, and extended meat products provided herein may comprise various other microbial compounds and other non-microbial ingredients. In most embodiments, the doughs, meat structured protein products, or extended meat products provided herein comprise any one of these other microbial compounds or other non-microbial ingredients at between about 0.01% and about 5% by weight.

Examples of such microbial compounds or other non-microbial ingredients include but are not limited to amino acids and amino acid derivatives (e.g., 1-aminocyclopropane-1-carboxylic acid, 2-aminoisobutyric acid, alanine, arginine, aspartic acid, canavanine, catecholamine, citruline, cysteine, essential amino acids, glutamate, glutamic acid, glutamine, glycine, histidine, homocysteine, hydroxyproline, hypusine, isoleucine, lanthionine, leucine, lysine, lysinoalanine, methionine, mimosine, non-essential amino acids, ornithine, phenylalanine, phenylpropanoids, photoleucine, photomethionine, photoreactive amino acids, proline, pyrrolysine, selenocysteine, serine, threonine, tryptophan, tyrosine, valine), anti-inflammatory agents (e.g., leukotriene antagonists, lipoxins, resolvins), antibiotics (e.g., alamethicin, erythromycin, tetracyclines), antimicrobial agents (e.g., potassium sorbate), antiparasitic agents (e.g., avermectins), buffering agents (e.g., citrate), clotting agents (e.g., thromboxane), coagulants (e.g., fumarate), coenzymes (e.g., coenzyme A, coenzyme C, s-adenosyl-methionine, vitamin derivatives), cross-linking agents (e.g., beta 1,3 glucan transglutaminase, calcium salts, magnesium salts), dairy protein (e.g., casein, whey protein), dietary minerals (e.g., ammonium, calcium, fat soluble minerals, gypsum, iron, magnesium, potassium, aluminum), disaccharides (e.g., lactose, maltose, trehalose), edulcorants (e.g., artificial sweeteners, corn sweeteners, sugars), egg protein (e.g., ovalbumin, ovoglobulin, ovomucin, ovomucoid, ovotransferrin, ovovitella, ovovitellin), elasticizing agents (e.g., gluten), emulsifiers (e.g., lecithin, lecithins), enzymes (e.g., hydrolase, oxidoreductase, peroxidase), essential nutrients (e.g., alpha-linolenic acid, gamma-linolenic acid, linoleic acid, calcium, iron, omega-3 fatty acids, zinc), fat soluble compounds, flavones (e.g., apigenin, chrysin, luteolin, flavonols, daemfero, datiscetin, myricetin), glycoproteins, gums (e.g., carob bean gum, guar gum, tragacanth gum, xanthan gum), hemoproteins (e.g., hemoglobin, leghemoglobin, myoglobin), humectants (e.g., polyethylene glycol, propylene glycol, sorbitol, xylitol), isoprenes, isoprenoid pathway compounds (e.g., mevalonic acid, dimethylallyl pyrophosphate, isopentenyl pyrophosphate), isoprenoids or isoprenoid derivatives (e.g., dolichols, polyprenols), liver X receptor (LXR) agonists and antagonists, meat proteins (e.g., collagen), mechanically separated meat, metabolic pathway intermediates (e.g., oxaloacetate, succinyl-CoA), monosaccharides (e.g., fructose, galactose, glucose, lactose, lyxose, maltose, mannose, ribose, ribulose, xylulose), neuroactive compounds (e.g., anandamide, cannabinoids, cortisol, endocannabinoids, gamma-aminobutyric acid, inositol), neutraceuticals, nucleic acids (e.g., DNA, RNA, rRNA, tRNA), nutritional supplements (e.g., carnitine, fumarate, glucosamine), oil-soluble compounds, organ meat, oxidizing agents (e.g., quinones), partially defatted tissue and blood serum proteins, plasticizing materials, polyols (e.g., alkylene glycols, butanediols, glycerine, glycerol, glycerol, mannitol, propylene glycol, sorbitol, xylitol), polysaccharides (e.g., pectin, maltodextrin, glycogen, inulin), porphyrins, secondary metabolites (e.g., polyketides), secosteroids, spices, steroids (e.g., C18-carbon containing steroids, C19-carbon containing steroids, C21-carbon containing steroids, cholesterol, cycloartenol, estradiol, lanosterol, squalene), sterols (e.g., betasitosterol, bras sicasterol, cholesterol, ergosterol, lanosterol, oxysterols, phytosterols, stigmasterol), tannins (e.g., ellagic tannins, ellagic tannins from roasted oak wood, gallic tannins, proanthocyanidin tannins from aromatic grape skin, proanthocyanidin tannins from grape seeds, proanthocyanidin tannins from grape skin, profisetinidin tannins, tannins from green tea leaves, tannins from sangre de drago), terpenes (e.g., diterpenes, monoterpenes, sesquiterpene, squalane, tetraterpenes, triterpenes), thickening agents (e.g., guar gum, pectin, xanthan gum, agar, alginic acid and its salts, carboxymethyl cellulose, carrageenan and its salts, gums, modified starches, pectins, processed Eucheuma seaweed, sodium carboxymethyl cellulose, tara gum), vitamins (e.g., alpha-tocopherol, alpha-tocotrienol, beta-tocopherol, beta-tocotrienol, delta-tocopherol, deltatocotrienols, fat soluble vitamins, gamma-tocopherol, gamma-tocotrienol, pantothenic acid, vitamin A, vitamin B-12, vitamin B-12, vitamin C, vitamin D, vitamin E, vitamin E, vitamin K, water soluble vitamins), water-soluble compounds, wax esters, and xenoestrogens (e.g., phytoestrogens).

Further examples include but are not limited to antioxidants (e.g., carotenes, ubiquinone, resveratrol, alpha-tocopherol, lutein, zeaxanthin, “2,4-(tris-3′,5′-bitert-butyl-4′-hydroxybenzyl)-mesitylene (i.e., Ionox 330)”, “2,4,5-trihydroxybutyrophenone”, “2,6-di-tertbutyiphenol”, “2,6-di-tert-butyl-4-hydroxymethylphenol (i.e., Ionox 100)”, “3,4-dihydroxybenzoic acid”, 5-methoxy tryptamine, “6-ethoxy 1,2-dihydro-2,2,4-trimethylquinoline”, acetyl gallate, alpha-carotene, alpha-hydroxybenzyl phosphinic acid, alphaketoglutarate, anoxomer, ascorbic acid and its salts, ascorbyl palmitate, ascorbyl stearate, benzyl isothiocyanate, beta naphthoflavone, beta-apo-carotenoic acid, beta-carotene, beta-carotene, butylated hydroxyanisole (BHA), butylated hydroxytoluene (BHT), caffeic acid, canthaxantin, carnosol, carvacrol, catalase, catechins, chlorogenic acid, citric acid and its salts, clove extract, coffee bean extract, di-stearyl thiodipropionate, dilauryl thiodipropionate, dodecyl gallate, edetic acid, ellagic acid, erythorbic acid, esculetin, esculin, ethyl gallate, ethyl maltol, ethylenediaminetetraacetic acid (EDTA), eucalyptus extract, eugenol, ferulic acid, flavanones, flavones, flavonoids, flavonoids, flavonols, fraxetin, fumaric acid, gallic acid, gentian extract, gluconic acid, glycine, gum guaiacum, hesperetin, hydroquinone, hydroxycinammic acid, hydroxyglutaric acid, hydroxytryrosol, hydroxyurea, isoflavones, lactic acid and its salts, lecithin, lecithin citrate; R-alpha-lipoic acid, lutein, lycopene, malic acid, maltol, methyl gallate, mono isopropyl citrate, monoglyceride citrate, morin, N-acetylcysteine, N-hydroxysuccinic acid, “N,N′diphenyl-p-phenylenediamine (DPPD)”, natural antioxidants, nordihydroguaiaretic acid (NDGA), octyl gallate, oxalic acid, p-coumaric acid, palmityl citrate, phenothiazine, phosphates, phosphatidylcholine, phosphoric acid, phytic acid, phytylubichromel, pimento extract, polyphosphates, propyl gallate, quercetin, retinyl palmitate, rice bran extract, rosemary extract, rosmarinic acid, sage extract, sesamol, silymarin, sinapic acid, sodium erythorbate, stearyl citrate, succinic acid, superoxide dismutase (SOD), synthetic antioxidants, syringic acid, tartaric acid, taurine, tertiary butyl hydroquinone (TBHO), thiodipropionic acid, thymol, tocopherols, tocotrienols, trans resveratrol, trihydroxy butyrophenone, tryptamine, tyramine, tyrosol, ubiquinone, uric acid, vanillic acid, vitamin K and derivates, wheat germ oil, zeaxanthin).

Further examples include but are not limited to coloring agents (e.g., FD&C (Food Drug & cosmetics) Red Nos. 14 (erythrosine), FD&C Red Nos. 17 (allura red), FD&C Red Nos. 3 (carmosine), FD&C Red Nos. 4 (fast red E), FD&C Red Nos. 40 (allura red AC), FD&C Red Nos. 7 (ponceau 4R), FD&C Red Nos. 9 (amaranth), FD&C Yellow Nos. 13 (quinoline yellow), FD&C Yellow Nos. 5 (tartazine), FD&C Yellow Nos. 6 (sunset yellow), artificial colorants, natural colorants, titanium oxide, annatto, anthocyanins, beet juice, beta-APE 8 carotenal, beta-carotene, black currant, burnt sugar, canthaxanthin, caramel, carmine/carminic acid, cochineal extract, curcumin, lutein, mixed carotenoids, monascus, paprika, red cabbage juice, riboflavin, saffron, titanium dioxide, turmeric).

Further examples include but are not limited to flavoring agents, flavor enhancers, and flavor stabilizers (e.g., 5′-ribonucleotide salts, glutamic acid salts, glycine salts, guanylic acid salts, hydrolyzed proteins, hydrolyzed vegetable proteins, insomniac acid salts, monosodium glutamate, sodium chloride, galacto-oligosaccharides, sorbitol, animal meat flavor, animal meat oil, artificial flavoring agents, aspartame, fumarate, garlic flavor, herb flavor, malate, natural flavoring agents, natural smoke extract, natural smoke solution, onion flavor, shiitake extract, spice extract, spice oil, sugars, yeast extract).

Further examples include but are not limited to pH and/or ionic strength adjusting agents (i.e., agents that raise or lower the pH and/or ionic strength of a solution). The pH and/or ionic strength adjusting agent may be organic or inorganic. Examples of suitable pH and/or ionic strength adjusting agents include but are not limited to salts, ionic salts, alkali metals, alkaline earth metals, and monovalent or divalent cationic metals. Examples of suitable salts include but are not limited to hydroxides, carbonates, bicarbonates, chlorides, gluconates, acetates, or sulfides. Examples of suitable monovalent or divalent cationic metals include but are not limited to calcium, sodium, potassium, and magnesium. Examples of suitable acidic pH adjusting agents include but are not limited to acetic acid, hydrochloric acid, citric acid, succinic acid, and combinations thereof. Examples of suitable basic pH adjusting agents include but are not limited to potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof.

### Post-Processing

The protein fibrous products provided herein can be further processed to yield post-processed meat structured protein products.

Post-processing may involve but is not limited to vacuum tumbling, marinating, dehydrating, hydrating (e.g., to yield hydrated protein fibrous products), flavoring, tenderizing, injecting, grilling, boiling in vinegar, contacting with a pH adjusting agent, coloring, or combinations thereof performed either together or in sequence.

Dehydrating and certain other post-processing can involve water loss of between about 30% and about 90% by weight compared to the protein fibrous product. In some embodiments, dehydrating results in meat structured protein products that comprise less than about 5% by weight of water compared to protein fibrous products.

Hydrating and certain other post-processing can involve water uptake of up to about 95% by weight compared to the protein fibrous product. In some embodiments, hydrating comprises the steps of mixing the protein fibrous product with a lesser, equal, or greater part by weight of water, and simmering the mixture in a covered vessel while stirring. In other embodiments, hydrating comprises the step of injecting water into the protein fibrous product using a SpitJack needle injector gun. In some embodiments, marinating comprises the step of mixing the protein fibrous product with a lesser, equal, or greater part by weight of water comprising flavoring, and then vacuum tumbling the mixture in a vacuum tumbler.

In some embodiments, post-processing involves mixing with 5% or less by weight of one or more ingredients derived from animal. Without being bound by theory, it is believed that such small amount of an animal ingredient may improve the binding, color, aroma, flavor, or other property of certain embodiments of the meat structured protein products provided herein. Examples of such ingredients include but are not limited to animal meat and components thereof, including interstitial fluid extracted from animal meat.

It is also within the scope of the present invention that the microbial biomass is added to the protein fibrous product during post-processing, for example by soaking, liquid spraying, dry spraying, spray drying, ink jet application, or 3D printing. In some such embodiments, the microbial biomass is added as a binding agent. In some such embodiments, the microbial biomass comprises native protein. In other such embodiments, the microbial biomass is added as a nutritional supplement.

In some embodiments, the meat structured protein products provided herein are shaped into patties. Patty cohesiveness can be achieved by the addition of a binding agent. Examples of suitable binding agents include but are not limited to carob bean gum, cornstarch, dried whole eggs, dried egg whites, gum arabic, konjac flour maltodextrin, potato flakes, tapioca starch, wheat gluten, vegetable gum, carageenan, methylcellulose, and xanthan gum. A suitable binding agent can be identified by titrating different binding agents against the cohesiveness and fracturability of the patty. In some embodiments, the binding agent is carageenan. In other embodiments, the binding agent is methyl cellulose. In preferred embodiments, the binding agent is a mixture of carageenan and methylcellulose.

### Extended Meat Products

In a further aspect, the present invention provides extended meat products that are produced by extending animal meat with meat structured protein products as provided herein.

The animal meat may be intact, in chunks, in steak form, ground, finely textured, trim or residues derived from processing frozen animals, low temperature rendered, mechanically separated or deboned (MDM, which is a meat paste that is recovered from animal bones, and a comminuted product that is devoid of the natural fibrous texture found in intact muscles) (i.e., meat removed from bone by various mechanical means), cooked, or combinations thereof. The animal meat may include muscle, skin, fat (including rendered fat such as lard and tallow, flavor enhanced animal fats, fractionated or further processed animal fat tissue), or other animal components.

Animal meat may be extended by blending with meat structured protein products as provided herein before or after post-processing, optionally together with other constituents, including but not limited to dietary fiber, animal or plant lipid, or animal-derived protein material (e.g. casein, caseinates, whey protein, milk protein concentrate, milk protein isolate, ovalbumin, ovoglobulin, ovomucin, ovomucoid, ovotransferrin, ovovitella, ovovitellin, albumin globulin, and vitellin). Preferably, the blended meat structured protein products and the animal meat have similar particle sizes. The amount of meat structured protein products in relation to the amount of animal meat during blending will vary depending on the intended use of the extended meat products. By way of example, when a significantly vegetarian composition that has a relatively small degree of animal flavor is desired, the concentration of animal meat in the extended meat may be about 45%, about 40%, about 35%, about 30%, about 25%, about 20%, about 15%, or about 10% by weight. Alternatively, when a composition having a relatively high degree of animal meat flavor is desired, the concentration of animal meat in the extended meat product may be about 50%, about 55%, about 60%, about 65%, about 70%, or about 75% by weight. Depending upon the intended use of the extended meat product, the animal meat is typically precooked to partially dehydrate the flesh and to prevent the release of fluids during further processing applications (e.g., such as retort cooking), to remove natural liquids or oils that may have strong flavors, to coagulate the animal protein and loosen the meat from the skeleton, or to develop desirable and textural flavor properties. The precooking process may be carried out in steam, water, oil, hot air, smoke, or a combination thereof. The animal meat is generally heated until the internal temperature is between about 60° C. and about 85′C.

### Packaging and Labeling

The meat structured protein products provided herein may be packaged to keep them clean, fresh, contained, or safe; to facilitate inventory control, handling, distribution, stacking, display, sale, opening, reclosing, use, or reuse; or to enable portion control. Suitable packing includes but is not limited to trays, trays with overwrap, bags, cups, films, jars, tubs, bottles, pads, bowls, platters, boxes, cans, cartons, pallets, wrappers, containers, bags-in-boxes, tubes, capsules, vacuum packagings, pouches, and variations and combinations thereof. The packaging can be made of plastic, paper, metal, glass, paperboard, polypropylene, PET, Styrofoam, aluminum, or combinations thereof.

The packaging may carry one or more labels that communicate information to the consumer or that support the marketing of the meat structured protein products. In some embodiments, the packaging carries a label required by governmental regulation. In some such embodiments, the label is required by regulation of the U.S. Food and Drug Administration (FDA) or the U.S. Department of Agriculture. In other such embodiments, the label is required by regulation of the European Food Safety Authority. In some embodiments, the governmental regulation is Title 21 of the FDA section of the code of federal regulations. In some embodiments, the label indicates that the enclosed meat structured protein product is free of genetically modified organisms. In some embodiments, the label indicates that the enclosed meat structured protein product is free of gluten. In some embodiments, the label indicates that the enclosed meat structured protein product is Kosher. In some embodiments, the label indicates that the enclosed meat structured protein product is free of cholesterol. In some embodiments, the label indicates that the enclosed meat structured protein product is vegan. In some embodiments, the label indicates that the enclosed meat structured protein product is free of an allergen. In some embodiments, the label indicates that the enclosed meat structured protein product is free of soy. In some embodiments, the label indicates that the enclosed meat structured protein product is free of nuts.

### Marketing and Sale

The meat structured protein products provided herein can be sold in any suitable venue. Such venues include but are not limited to internet, grocery stores, supermarkets, discounters, mass marketers (e.g., Target, Wal-Mart), membership warehouses (e.g., Costco, Sam's Club), military outlets, drug stores, restaurants, fast food restaurants, delis, markets, butcher shops, health food stores, organic food stores, private caterers, commercial caterers, food trucks, restaurant chains, kiosks, street carts, street vendors, cafeterias (e.g., school cafeterias, hospital cafeterias), and the like.

All references, including publications, patent applications, and patents, cited herein are hereby incorporated by reference to the same extent as if each reference were individually and specifically indicated to be incorporated by reference and/or were set forth in its entirety herein.

### EXAMPLES

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### Example 1

### Production of Yeast Biomass Comprising Food Products by Thermoplastic Extrusion

For each meat structured protein product produced, a mix of the dry ingredients as listed in Table 1 was blended for 5 minutes in a ribbon blender. The dry mix was transferred to the hopper of a gravimetric feeder that metered the blend through the feed port of a twin screw extruder (MPF 50/25 Co-rotating Twin-Screw Extruder [APV Baker, Grand Rapids, Mich.]) at the feed rates indicated in Table 1. At the same time, the liquid mixes shown in Table 1 were pumped through liquid feed ports located downstream of the dry mix feed port at the feed rates shown in Table 1. The twin screw extruder mixed the dry and liquid mixes to generate dough compositions of the compositions shown in Table 2. Extrusion parameters are shown in Table 3.

TABLE 1
Dry Mix Compositions (% by weight) and Feed Rates (kg/hr)

| | 141230LCY8LP2 | 141230LCY10LL3 | 141209BY2B | EBY4-1 | 141212LCY8L1D |
|---|---|---|---|---|---|
| Pea Protein Isolate | 100 | 60 | 90.9 | 93.5 | 100 |
| Yeast Powder | 0 | 40* | 0 | 5** | 0 |
| Gypsum | 0 | 0 | 4.1 | 0 | 0 |
| Flavoring Agents | 0 | 0 | 2.5 | 0 | 0 |
| Potassium Bicarbonate | 0 | 0 | 2.5 | 1 | 0 |
| Calcium Hydroxide | 0 | 0 | 0 | 0.5 | 0 |
| Feed Rate | 7.74 | 13.14 | 31 | 9.8 | 12.34 |

Pea protein isolate (F85M) was obtained from Roquette, Inc., Lestrem, France, and has a composition of 80% protein, 6% fat, 3% carbohydrate, 1% dietary fiber, 4% ash, and 7% water.
*Partially autolyzed Sacharoymyces cerevisiae (Bioferm) obtained from Fermentis, France.
**Autolyzed (i.e., fully hydrolyzed) Candidautilis (Torula) Provesta 033 (pH 8.5) obtained from Ohly, Hamburg, Germany. Gypsum (Calcium Sulfate, Dihydrate, Terra Alba) was obtained from CGC, Inc., Chicago, IL, and has a composition of 80.0% ash (23,000 mg calcium/100 g) and 20.0% water.
Potassium bicarbonate was obtained from Flow K; Church & Dwight Co., Inc. (Ewing, NJ), having a composition of 69.0% ash (39,060 mg potassium/100 g) and 31% water.
Calcium hydroxide was obtained from Mississippi Lime, St. Louis, MO.

TABLE 2
Liquid Mix Compositions (% by weight) and Feed Rates (kg/hr)

| | | | | |
|---|---|---|---|---|
| 141230LCY8LP2 | 141230LCY10LL3 | 141209BY2B | EBY4-1 | 141212LCY8L1D |

Pump 1 (located about 203 nm downstream of dry mix feed port)

| | | | | | |
|---|---|---|---|---|---|
| Water | 0 | 0 | 0 | 100 | 0 |
| Feed Rate | n/a | n/a | n/a | 9.33 | n/a |

Pump 2 (located about 330 nm downstream of dry mix feed port)

| | | | | | |
|---|---|---|---|---|---|
| Water | 0 | 0 | 0 | 40 | 0 |
| Yeast Slurry | 100 | 100 | 100 | 0 | 99.5 |
| Yeast Slurry pH | 8 | 10 | 4 | n/a | not measured |
| Transglutaminase | 0 | 0 | 0 | 0 | 0.5 |
| Sorbitol | 0 | 0 | 0 | 60 | 0 |
| Feed Rate | 20.27 | 20.27 | 19.4 | 1.2 | 9 |

29% autolyzed yeast slurry was prepared using Bioferm (Fermentis, France) by mixing 5 kg of yeast in a final volume 12 kg water containing 425 grams of calcium hydroxide to give a final pH of 8.0.
Translglutaminase (TG-GB212) was obtained from Taixing Dongsheng Food Science and Technology Co., Ltd, China.

TABLE 3
Dough Compositions (% by weight)

| | 141230LCY8LP2 | 141230LCY10LL3 | 141209BY2B | EBY4-1 | 141212LCY8L1D |
|---|---|---|---|---|---|
| Protein | 22 | 19 | 45 | 36 | 55 |
| Carbohydrate | 0.8 | 0.7 | 2.2 | 4.9 | 2.1 |
| Fiber | 0.3 | 0.2 | 0.6 | 0.5 | 0.7 |
| Lipid | 1.7 | 1.4 | 3.4 | 2.7 | 4.1 |
| Water | 53 | 44 | 32 | 52 | 27 |
| Yeast Biomass | 22 | 34 | 12 | 2.4 | 9.4 |

TABLE 4
Extrusion Parameters

| | |
|---|---|
| Screw Profile Assembly | Zones 1-3: conveying screw elements; Zones 4, 5: mixing screw elements; Zones 6-8: |
| | medium shear screws; Zone 9: final mixing screws. |
| | EBY4-1: Zones 1-3: conveying screw elements; Zones 4-8: mixing screw elements |
| | interstepped with single lead elements; Zone 9: final lead elements. |
| Extruder Barrel | 9 zones, each individually controlled via an electric heater cartridge (4 × 900 W per |
| | zone) and a cooling water jacket (supplied with building water, 60° F.); overall barrel |
| | length = 1.250 mm: length of each zone = 125 mm. |
| Barrel Heater Set Points | 141209BY2B, 141212LCY8L1D: Zones 1-4: 30-35° C.; Zones 5-7: 55-91° C.; Zones 8-10: |
| | 111-125° C. |
| | 141230LCY8LP2, 141230LCY10LL3: Zones 1-3: 30-50° C.; Zone 4-5: 50-70; Zone |
| | 69: 125-149° C. |
| | EBY4-1: Zones 1-5: 32-50° C.; Zones 6-7: 110-112° C.; Zones 8-9: 135° C. |
| Extrusion Screws | Co-rotating in counter-clockwise direction at 180-200 revolutions per minute. |
| Barrel Pressure | 50-250 psi |
| | EBY4-1: 10-50 psi |
| Product Temperature | 100-116° C. |
| | EBYY4-1: 130-140° C. |

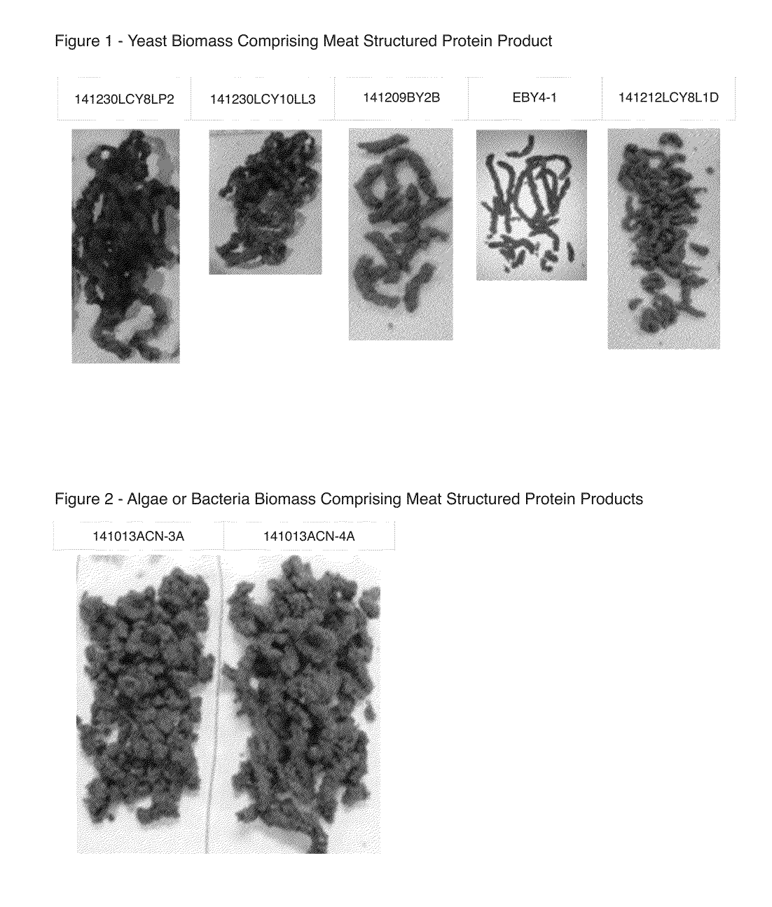

The protein fibrous products emerged from the extruder as tripe-like strings (141230LCY8LP2 and 141230LCY10LL3) or as short strands of crumbles (141209BY2B, EBY4-1, and 141212LCY8L1D), as seen in FIG. 1.

TPA was performed using a TA.XT Express Texture Analyzer (Texture Technologies Corp., Hamilton, Mass.) and a polymethylmethacrylate cylinder probe of 25 mm diameter (Texture Technologies Corp., Hamilton, Mass.). The disc probe was used to compress each sample using a trigger force of 20 g to 30% compression in a 2-cycle analysis at a test speed of 5 mm/sec. The deformation curve of the sample was obtained, and from the deformation curve was derived the Forcel, which describes the hardness of the sample, as described in Food Texture and Viscosity Second Edition: Concept and Measurement, Dr. Malcolm C. Bourne, April 2002, Academic Press, New York. Average measures were obtained from the analysis of 3 independent samples or 3 non-overlapping regions of each product. Hardness data for the samples are shown in Table 5.

TABLE 5
TPA Hardness (g/mm\hat{ }2)

| 141230LCY8LP2 | 141230LCY10LL3 |
|---|---|
| 47.24 + 3.96 | 30.47 + 6.97 |

### Example 2

### Production of Algae or Bacteria Biomass Comprising Food Products by ThermoPlastic Extrusion

TABLE 6
Dry Mix Compositions (% by weight)

| | 141013ACN-3 | 141013ACN-4 |
|---|---|---|
| Pea Protein Isolate | 14.54 | 14.54 |
| Soy Protein Isolate | 57.25 | 57.25 |
| Rice Flour | 7 | 7 |
| Soy Fiber | 5.22 | 5.22 |
| Carrot Fiber | 3.5 | 3.5 |
| Flavoring Agents | 5.6 | 5.6 |
| Canola Oil | 1.9 | 1.9 |
| Whole Cell Powders | 5 (Chlorella vulgaris) | 5 (Arthrospira sp.) |

Pea protein isolate (F85M) was obtained from Roquette, Inc., Lestrem, France, and has a composition of 80% by weight of protein, 6% by weight of fat, 3% by weight of carbohydrate, 1% by weight of dietary fiber, 4% by weight of ash, and 7% by weight of water.
Soy protein isolate (HII65) was obtained from Harvest Innovations, Indianola, IA, and has a composition of 61.17% by weight of protein, 22.8% by weight of carbohydrate (12.4% by weight of edible fiber), 7.08% by weight of lipid, and 6.02% by weight of ash.
Rice flour (Remyflo S 200) was obtained from Beneo-Remy, Rumylaan, Belgium, and has a composition of 10% by weight of protein, 85% by weight of carbohydrate (0.25% by weight of edible fiber), 1.5% by weight of lipid, and 0.8% by weight of ash.
Soy fiber (Cenergy FMS NA IP) was obtained from Solae, St. Louis, MO, and has a composition of about 11% by weight of protein, about 77% by weight of carbohydrate (about 71% by weight of edible fiber), about 0.5% by weight of lipid, and about 4% by weight of ash.
Carrot fiber (Hybrobind Carrot Fiber) was obtained from Wm. Bolthouse Farms, Inc., Bakersfield, CA, and has a composition of about 2.45% by weight of protein, about 86.4% by weight of carbohydrate (about 86% by weight of edible fiber), about 0.39% by weight of lipid, and about 4.4% by weight of ash.
Canola oil (Non-GMO Canola Oil #5050) was obtained from Columbus Vegetable Oils, Des Plaines, IL.
Dulse and Kombu whole cell powders were obtained from kalyx.com. Chlorella and Spirulina whole cell powders were obtained from nuts.com.

Meat structured protein products were produced as described in Example 1 using the dry mixes described in Table 6, fed at a rate of 6.7 kg/hr. The liquid mix consisted of water, fed through a pump located downstream of the dry mix feed port at a feed rate of 10.3 kg/hr. The twin screw extruder mixed the dry and liquid mixes to generate dough compositions containing about 26% by weight of plant (pea and soy) protein, about 2.1% by weight of plant lipid, about 6.3% by weight of plant carbohydrate (about 2.7% by weight of edible fiber), about 63% by weight of water, and about 2% by weight of algae (Chlorella vulgaris) or bacteria (Arthrospira sp.) biomass.

Extrusion parameters are shown in Table 7.

TABLE 7
Extrusion Parameters

| | |
|---|---|
| Screw Profile Assembly | Zones 1-3: conveying screw elements; |
| | Zones 4, 5: mixing screw elements; Zones 6-8: |
| | medium shear screws; Zone 9: final mixing |
| | screws. |
| Extruder Barrel | 9 zones, each individually controlled via an |
| | electric heater cartridge (4 × 900 W per zone) |
| | and a cooling water jacket (supplied with |
| | building water, 60° F.); overall barrel length = |
| | 1,250 mm; length of each zone = 125 mm. |
| Barrel Heater Set Points | Zones 1-5: 18-29° C.; Zones 6: 66° C.; |
| | Zones 7-9: 106-144° C. |
| Extrusion Screws | Co-rotating in counter-clockwise direction at |
| | 200 revolutions per minute. |
| Barrel Pressure | 19 |
| Product Temperature | 115° C. |

The protein fibrous product emerged from the extruder as short strands of crumbles (FIG. 2).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed is:

1. A meat structured protein product, wherein the meat structured protein product has a moisture content of at least 30% by weight and wherein such meat structured protein product, further, comprises
a) protein fibers that are substantially aligned; and
b) at least 2% by weight of microbial biomass.

2. A meat structured protein product of claim 1 which comprises between about 5% and about 70% of microbial biomass.

3. A meat structured protein product of claim 1 which comprises between about 4% and about 10% of microbial biomass.

4. A meat structured protein product of claim 1 wherein the microbial biomass is an algae biomass.

5. A meat structured protein product of claim 1 wherein the microbial biomass is a fungi biomass.

6. A meat structured protein product of claim 1 wherein the microbial biomass is a bacteria biomass.

7. A meat structured protein product of claim 1 wherein the microbial biomass further comprises at least 2% by weight of whole cell microbes.

8. A meat structured protein product of claim 1 wherein at least about 50% of the microbial biomass comprises whole cell microbes.

9. A meat structured protein product of claim 1 wherein at least about 95% of the microbial biomass comprises whole cell microbes.

10. A meat structured protein product of claim 1 which further comprises between about 5% and about 68% by weight of non-microbial protein, between about 0.5% and about 10% by weight of non-microbial lipid, and between about 0.5% and about 20% by weight of non-microbial carbohydrate.

11. A meat structured protein product of claim 1 which is a protein fibrous product.

12. A protein fibrous product of claim 4 which has a moisture content between about 40% and about 60% by weight.

13. A meat structured protein product of claim 1 which is a hydrated protein fibrous product.

14. A hydrated protein fibrous product of claim 13 which has a moisture content between about 60% and about 80%.

15. A meat structured protein product of claim 1, further comprising less than about 20% of an animal meat to provide an extended meat product.

16. A meat structured protein product of claim 1, further comprising at least about 50% of an animal meat to provide an extended meat product.

17. A process for producing a meat structured protein product comprising protein fibers that are substantially aligned, wherein the process comprises:
a) combining water and a microbial biomass comprising microbial protein;
b) shearing and heating the dough so as to denature the proteins in the microbial protein material and produce protein fibers that are substantially aligned in a fibrous structure; and
c) setting the dough to fix the fibrous structure previously obtained, thereby obtaining a meat structured protein product having a moisture content of at least 30% by weight and comprising at least 2% by weight of microbial biomass.

18. A process of claim 17 wherein the meat structured protein product produced is a protein fibrous product.

19. A process of claim 18 wherein the protein fibrous product produced has a moisture content of between about 40% and about 60% by weight and which further comprises combining with the water and microbial biomass comprising microbial protein (a) non-microbial protein, (b) non-microbial lipid, and (c) non-microbial carbohydrate so as to obtain a protein fibrous product comprising between about 5% and about 68% by weight of non-microbial protein, between about 0.5% and about 10% by weight of non-microbial lipid, and between about 0.5% and about 20% by weight of non-microbial carbohydrate.

20. A process of claim 17 which further comprises the step of subjecting the meat structured protein product produced by setting the dough to fix the fibrous structure to post-processing.

21. A process of claim 20 wherein the meat structured protein product produced is a hydrated protein fibrous product.

22. A process of claim 21 wherein the hydrated protein fibrous product produced has a moisture content of between about 60% and about 80% by weight and which further comprises combining with the water and microbial biomass comprising microbial protein (a) non-microbial protein, (b) non-microbial lipid, and (c) non-microbial carbohydrate so as to obtain a protein fibrous product comprising between about 5% and about 68% by weight of non-microbial protein, between about 0.5% and about 10% by weight of non-microbial lipid and between about 0.5% and about 20% by weight of non-microbial carbohydrate.
